(19) United States
(12) Patent Application Publication
(10) Pub. No.: US 2002/0069039 A1
(43) Pub. Date: Jun. 6, 2002

(54) System and method for creating architectural descriptions of real-time simulations

(76) Inventors: Kenneth G. Ricks, Madison, AL (US); John M. Weir, Madison, AL (US)

Correspondence Address: James J. McGroary, NASA/Marshall Space Flight Center, LS01/Office of Chief Counsel, Huntsville, AL, 35812, US

(21) Appl. No.: 09/728,407

(22) Filed: Dec. 1, 2000

(51) Int. Cl. G06F 17/50

(52) U.S. Cl. 703/1

(57) ABSTRACT

A system for creating at a computer workstation a graphical description of the architecture of a simulation of a real-world system. The system of this invention generally includes a standardized set of pre-defined graphical node and arc elements that represent real system hardware and software processes and the relationships between them; a parameter data input window for further defining any desired graphical node and arc element; a graphical user interface for definition, selection, and arrangement of the graphical node and arc elements; and one or more simulation architecture data files for describing the total simulation architecture arrangement. Although the invention represents software processes as stated above, it also represents processes that occur in the real-world systems being modeled by the simulation that is graphically represented by the invention. In one embodiment of the invention, a user may group graphical node and arc elements into a summary construct called a “container,” which allows the user to simplify the graphical representation of the simulation. Using the above-defined components of the invention, a user may graphically represent any simulation architecture, existing or non-existent, simple or complex, at different levels of abstraction.

### APPLICATION FOR UNITED STATES LETTERS PATENT

Be it known that we, Kenneth G. Ricks, a citizen of United States, residing at 108 Springfield Lane, Madison, Ala. 35758, and John M. Weir, a citizen of United States, residing at 177 Yancy Road, Madison, Ala. 35758; have invented a new and useful “System and Method for Creating Architectural Descriptions of Real-Time Simulations.”

This invention was made by employees of the United States Government and may be manufactured and used by or for the Government for governmental purposes without the payment of any royalties.

A portion of the disclosure of this patent document contains material that may be subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### BACKGROUND OF THE INVENTION

This invention relates generally to computer-based simulations of the functioning of real world systems. More specifically, this invention, which is proprietarily known as “Simulation Architecture Description Language,” or “SADL,” pertains to systems for creating descriptions of the architecture of computer-based simulations by graphically representing the simulation at user-selected levels of abstraction. Using the system of the invention, a user can create an architectural description of a real-world system simulation completely and accurately. Furthermore, a user can rapidly change the visual description of the simulation in an orderly manner to shorten the time required to develop and analyze the simulation.

Computers have historically been used to simulate real-world systems. In fact, one of the reasons that computers were originally developed was to simulate real-world systems for testing and analysis. In that early era, computers performed simulations of real-world systems that were relatively simple, such as ballistic systems. However, as computers became integrated with the real-world systems, the task of simulating real-world systems became more difficult.

Today, computers and software make up a substantial part of many real-world systems, which has often caused the task of simulating real-world systems to be at least as complex as the real-world system itself. Real-world systems often involve many different types of computers working together in real time to perform extraordinarily difficult and sensitive tasks, such as occur on every NASA space shuttle mission. Extensive testing and analysis of these real-world systems is very demanding of computer resources, but is also critical to their ultimate success.

Simulating real-world systems completely and accurately on a computer is the most feasible and cost-effective way to test and analyze the systems and promote a successful outcome. The problem is that the current technological level of real-world systems has caused the simulations themselves to be so difficult as to threaten the value of the simulation process. For example, simulating a real-world system, where the real-world system incorporates a heterogeneous architecture and where the simulation must run in real-time to maximize the value of the simulation, has routinely required simplifications to be made to the simulation that significantly lessen the value of the simulation to its designer.

In fact, computer-based systems simulation has become so complex that previously-used ad hoc design paradigms have given way to high-level software design tools providing such efficiencies as code re-use, abstraction of implementation details, documentation support, tool support for evaluation and analysis, formalized design processes, and tight coupling between system modeling and system design. Specifically, the use of a standardized Architectural Description Language (ADL) in the related area of hardware/software co-design is being increasingly researched.

The result of the research in the prior art has been the development of several tools and design environments specifically targeted for high-level design of real-time simulation software. Many ADL's support different computational models and software architectural styles. There are less formal tools that provide a means to specify architectural information about a system and also use various models and styles. The literature refers to such tools as description languages, specification languages, requirements languages, and case tools.

Despite the number of available tools, few if any existing tools or environments support the computational model and architectural style of a unique design methodology for real-time simulation development. Exacerbating the problem is that most complex software systems do not conform to a single architectural style; rather, they involve a combination of styles, forming a heterogeneous architecture. Some existing tools do not adequately support low-level specification of the run-time characteristics of the simulation software. Tools that require task graphs and resource graphs as inputs representing executable software and its required computing resources do not accurately represent the high-level architecture of the simulation because hardware that does not function on the host computer is not supported. Other tools are available that are tailored to specific applications such as guidance, navigation, and control, but these tools lack the ability to describe the overall simulation. Data-flow modeling does not support synchronization between processes where there is no data sharing.

What is needed, then, is a tool or system that makes it easier to define, understand, and change the architecture of a simulation. SADL provides all of the advantages of high-level software design and accurately represents a unique design paradigm for real-time simulation development. This paradigm implements a unique representation of simulation software and hardware components that can represent the entire simulation at various levels of abstraction including the specification of the run-time characteristics of the simulation software.

### SUMMARY OF THE INVENTION

The present invention provides a system for creating at a computer workstation a graphical description of the architecture of a simulation of a real-world system. The system allows a user to define a graphical representation of a simulation that is largely unaffected by differences in the computing platform, system makeup, or simulation complexity. Allowing the user to define a graphical representation of a simulation gives the user direct control over the complexity of the simulation representation, particularly where the user is able to define hierarchical levels of simulation detail in the graphical representation. A simulation having a clear, concise representation is easier to understand than one with a poorly defined representation. In providing a user-definable, graphical representation of a simulation of a real-world system, the system of this invention reduces the costs of simulating real-world systems.

The system of this invention provides improvements over prior art architectural description languages and other systems by formalizing the simulation design process; maintaining tight coupling between the high-level graphical representation and the simulation's underlying implementation details; providing accurate documentation of the simulation; and by promoting code generation, code re-use, and design evaluation and testing.

Accordingly, the system of this invention generally includes: a standardized set of pre-defined graphical node elements; a standardized set of pre-defined graphical arc elements; a parameter data input window that can be associated with a particular graphical node or arc element for further defining the element; a graphical user interface for definition, selection, and arrangement of the graphical node and arc elements; and simulation architecture data files for describing the simulation architecture arrangement.

The set of graphical node elements is a set of graphical representations of the components of the simulations that represent real system hardware and processes. Graphical node elements may represent hardware devices or simulation software. It is important to note that although the node elements directly represent software processes, they at least indirectly represent processes that occur in the real-world systems being modeled by the simulation. Internal behavior of the graphical node elements is abstracted so that the elements can be represented as black box constructs. Graphical node elements representing simulation software may represent periodic, aperiodic, or continuous processes in the simulation. Preferably, each different type of graphical node element has a distinguishing characteristic that is visible to the user, such as a pre-defined shape, to distinguish that type from other types of graphical node elements.

The set of graphical arc elements is a set of graphical representations of timing, control, and data relationships among the graphical node elements. These timing, control, and data relationships, or “dependencies,” must be represented accurately in order to capture the high-level architecture of such a simulation. In a preferred embodiment of the invention, each type of graphical arc element has a distinguishing characteristic, such as line color, line style, or other appearance, to distinguish that type of graphical arc element from other types of graphical arc elements.

In one embodiment of the invention, a user may employ a novel graphical node element called a “simulation container” and/or a graphical arc element called a “communication container.” Simulation and communication containers are node and arc elements that graphically represent a combination of more than one of the graphical node and arc elements, respectively. “Containerizing” graphical elements creates a “black box”-type of abstraction that simplifies the graphical representation of the simulation by allowing a hierarchical structure of the real system in order to represent various levels of detail in the design.

A user may select and arrange the graphical node elements and graphical arc elements on the workstation to visually describe the simulation of the real-world system. The instrumentality for such selection and arrangement is a graphical user interface adapted for that purpose. The graphical user interface allows the user to select objects from the sets of standardized graphical node elements and graphical arc elements, and arrange them in a manner that accurately depicts the simulation of the real-world system components and the functional relationships between the real-world system components. When the user performs this task, the result is a visual description of the simulation architecture of a specific real system.

The graphical node and arc elements may be further defined by use of a parameter data input window. The parameter data input window allows the user to input parameter data that further characterizes and defines properties of the selected node and arc elements with which the parameter input data window is associated. These parameter input data can be referred to as “semantics.” Semantics can represent functional properties of a node or an arc as well as non-functional properties associated with a node or an arc, such as execution times and frequencies, which aid in scheduling and other types of non-functional analysis.

Using the above-defined components of the invention, one may graphically represent any simulation architecture, existing or not, complex or not, at different levels of abstraction.

In another embodiment of the invention, an output file generator to create an output text file. This output file is a textual representation of the graphical description of the simulation created by the user, including all instances of nodes, arcs, and their related semantics. The output file is capable of being used by many “down-stream” tools that can generate code, analyze the design, or perform process allocation and scheduling.

In light of the need for a tool that will provide descriptions of the overall simulation architecture of a real system at various levels of abstraction, it is an object of the invention to create a system having standardized graphical elements for representing the architecture of such a simulation at various levels of abstraction.

It is a further object of the invention to create detailed documentation of simulations and provide an interface for tools that provide such capabilities as code generation, design verification, and testing and evaluation.

It is a further object of the invention to provide a computing-platform-independent system for simulating a real-world system.

It is a further object of the invention to provide for additional tools for testing and evaluation of an existing computational model and architecture.

It is a further object of the invention to formalize the simulation design process.

It is a further object of the invention to provide a simulation design language that is tightly coupled to the underlying implementation details of the simulation.

It is a further object of the invention to provide consistent, updated simulation documentation.

It is a further object of the invention to promote code reuse between a plurality of simulations.

It is a further object of the invention to provide for code generation and design testing and evaluation.

In addition to the foregoing, further objects, features, and advantages of the present invention should become more readily apparent to those skilled in the art upon a reading of the following detailed description in conjunction with the drawings, wherein there are shown and described illustrated embodiments of the invention.

### BRIEF DESCRIPTION OF THE DRAWINGS

FIG. 1 is a block diagram generally showing the functional relationship between the system of the present invention and implementation tools used for further design and generation of a simulation of a real system.

FIG. 2 is a block and data flow diagram that shows the relationship of the system of the invention to other tools that use system output for simulation testing, analysis, and generation of simulation code.

FIG. 3 shows a graphical representation of the architecture of a simulation that was created using prior art graphic tools.

FIG. 4 is a table showing a standard set of pre-defined graphical node elements used in one embodiment of the system of the present invention.

FIG. 5 shows a data relationship between periodic processes as graphically represented by pre-defined node and arc elements used in the system of the invention.

FIG. 6(A) shows a synchronization relationship between two periodic processes as graphically represented by pre-defined node and arc elements used in the system of the invention.

FIGS. 6(B), 6(C), and 6(D) illustrate execution timelines associated with synchronization of the periodic processes shown in FIG. 6(A), with three possible relationships between process frequencies.

FIG. 7(A) shows a synchronization relationship between a periodic process and an aperiodic process as graphically represented by predefined node and arc elements used in the system of the invention.

FIG. 7(B) illustrates an execution timeline associated with synchronization of the periodic and aperiodic processes shown in FIG. 7(A)

FIG. 8(A) shows a synchronization relationship between two aperiodic processes as graphically represented by pre-defined node and arc elements used in the system of the invention.

FIG. 8(B) illustrates an execution timeline associated with synchronization of the aperiodic processes shown in FIG. 8(A).

FIG. 9(A) shows a synchronization relationship between a continuous process and a periodic process as graphically represented by pre-defined node and arc elements used in the system of the invention.

FIGS. 9(B) and 9(C) illustrate execution timelines associated with synchronization of the processes shown in FIG. 9(A), with two possible relationships between process frequencies.

FIG. 10(A) shows a synchronization relationship between a periodic process and a continuous process as graphically represented by predefined node and arc elements used in the system of the invention.

FIGS. 10(B) and 10(C) illustrate execution timelines associated with synchronization of the processes shown in FIG. 10(A), with two possible relationships between process frequencies.

FIG. 11 shows a window of the graphical user interface of the invention, with the window displaying a standard set of pre-defined node and arc elements and a visual description of the top-level architecture of a computer simulation of a real system created from the node and arc elements.

FIG. 12 shows the graphical user interface window of the system, further displaying the node and arc elements contained within the “Vehicle Simulation Container” shown at node 81 in FIG. 11.

FIG. 13 shows the graphical user interface window of the system, further displaying the node and arc elements contained within the “Hardware Interface” container shown at node 82 in FIG. 11.

FIG. 14 shows the graphical user interface window of the system, further displaying the node and arc elements contained within the “Housekeeping Software” container node shown at node 83 in FIG. 11.

FIG. 15 illustrates execution timelines associated with the processes graphically represented in the simulation architectures of FIGS. 12, 13, and 14.

FIG. 16 shows the graphical user interface window of the system, demonstrating another example of a visual description of the architecture of a computer simulation.

FIG. 17 is a parameter data input window associated with the graphical user interface of the system whereby a user may define or change the definition of parameter data input associated with node element 202 in FIG. 16.

FIG. 18 is a parameter data input window associated with the graphical user interface of the system whereby a user may define or change the definition of parameter data input associated with node element 205 in FIG. 16.

FIG. 19 is a parameter data input window associated with the graphical user interface of the system whereby a user may define or change the definition of parameter data input associated with node element 204 in FIG. 16.

FIG. 20 is a parameter data input window associated with the graphical user interface of the system whereby a user may define or change the definition of parameter data input associated with node element 207 in FIG. 16.

FIG. 21 is a parameter data input window associated with the graphical user interface of the system whereby a user may define or change the definition of parameter data input associated with arc element 209 in FIG. 16.

FIG. 22 shows a portion of the graphical user interface featuring a visual description of arc element 206 in FIG. 16 connecting node elements 204 and 205.

FIG. 23 is a parameter data input window associated with the graphical user interface of the system whereby a user may define or change the definition of parameter data input associated with arc element 206 in FIG. 16.

FIG. 24 shows a portion of the graphical user interface of the system featuring a visual description of arc element 209 in FIG. 16 connecting node elements 202 and 204.

FIG. 25 shows a portion of the graphical user interface of the system featuring a parameter data input window associated with arc element 209 in FIG. 24.

FIG. 26 shows a portion of the graphical user interface of the system featuring a parameter data input window associated with a timing and data relationship between two graphical node elements.

FIG. 27 shows a portion of the graphical user interface of the system featuring a visual description of arc element 208 in FIG. 16.

FIG. 28 shows a portion of the graphical user interface of the system featuring a parameter data input window associated with arc elements 223 and 224 in FIG. 27.

FIG. 29 shows a portion of the graphical user interface of the system featuring a parameter data input window associated with node element 222 in FIG. 27.

FIG. 30 is a listing of an output file generated by system and corresponding to the graphical representation of the simulation architecture in FIG. 16.

FIG. 31 is a block diagram of one embodiment of the system of the present invention.

FIG. 32 is a flowchart describing the basic steps associated with one embodiment of the method of the invention.

### DESCRIPTION OF THE PREFERRED EMBODIMENTS

In the system of the present invention, a computer workstation, in combination with an operating system and application software modules, is used to create architectural descriptions of simulations of real world systems. In cooperation with other simulation design and implementation tools, the system of this invention can be used to generate simulation software needed to implement the simulation on a computer.

The system of this invention includes a hierarchical language supporting multiple levels of abstraction. General high-level descriptions similar to the conventional box-and-line diagram in FIG. 3 are supported at the highest levels of abstraction. The specification of implementation specific details is supported through lower-level tools. This hierarchical design simplifies the porting of a simulation between computing platforms. The high-level specification requires no changes, but each platform requires different low-level tools to support the implementation details.

The system provides a graphical language. It uses a directed graph of nodes and arcs to represent the simulation architecture. Graphical node elements represent the simulation components and graphical arc elements represent their interactions.

The system also provides a means to describe non-functional properties associated with the simulation components such as execution times and frequencies of simulation software that can be used for scheduling purposes. The result is a directed graph with semantics associated with each node and arc giving these graphical elements the required information needed to enforce the desired simulation model and provide for advanced functions such as code generation, design analysis, and process allocation and scheduling via a toolset. Such functionality distinguishes this system from simulation descriptions found in conventional “dumb” box-and-line drawings such as that shown in FIG. 3.

System Overview

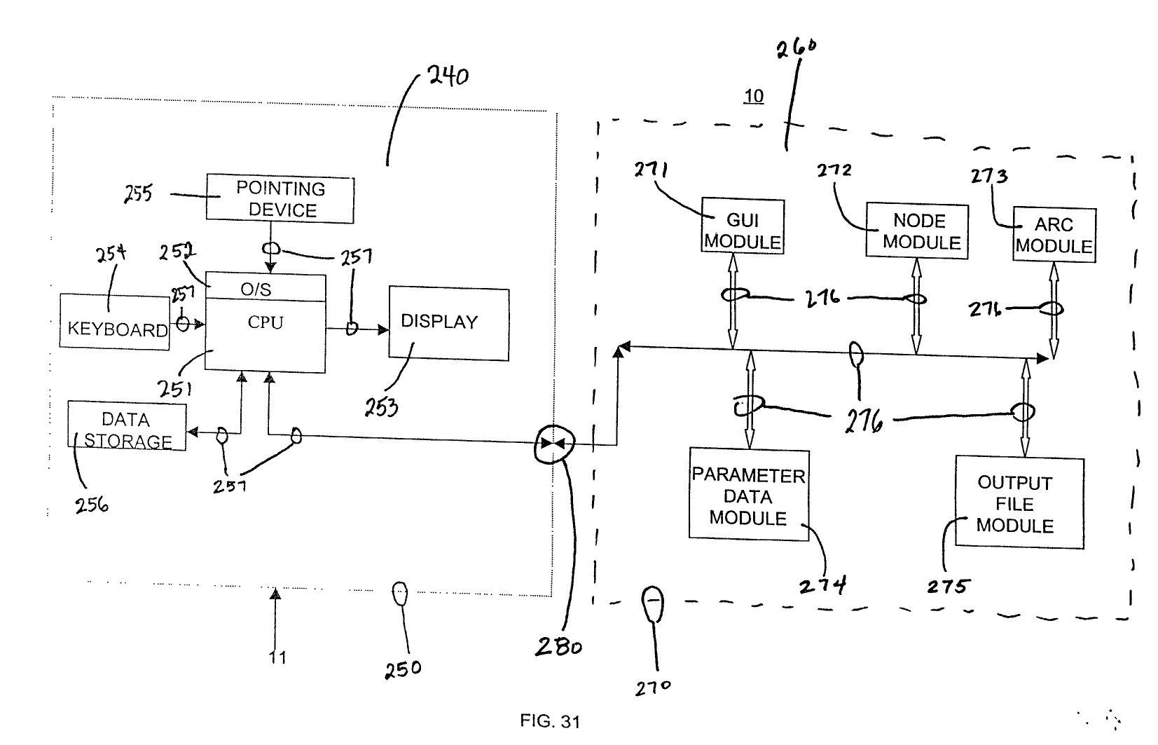

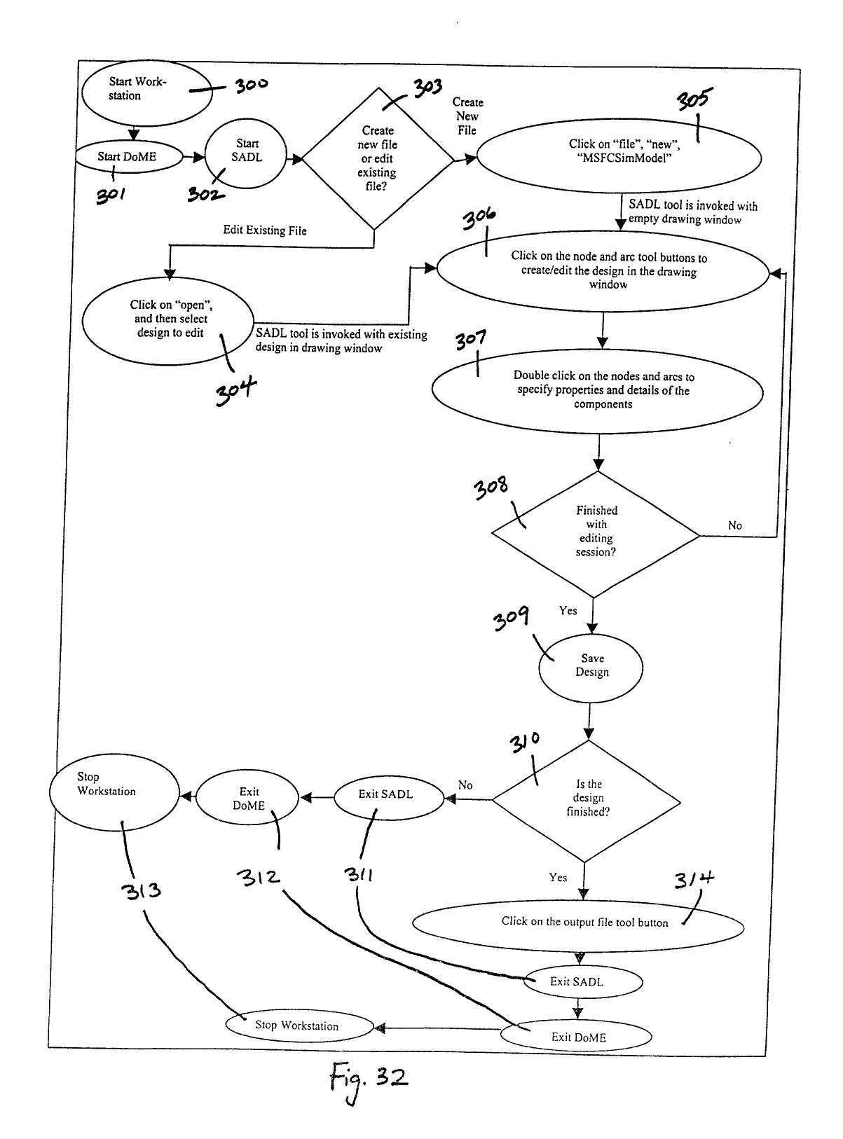

Referring to FIG. 31, an embodiment of the system 10 of the invention is implemented in a conventional computer workstation 240 that includes a central processing unit (CPU) 251 under the control of an operating system 252, a display 253, a keyboard 254, a pointing device 255, and a data storage device 256. The operating system 252 can be a combination of a conventional BIOS and a CPU operating platform such as UNIX, Windows, or LINUX, and will be capable of controlling the basic operations of the CPU, motherboard devices, and peripherals, including the generation of a cursor on display 253. The operating system 252, in combination with application software 260, also generates a graphical user interface (GUI) as described below. Pointing device 255 allows the user to position the cursor on display 253 and to manipulate objects and enter commands at the GUI.

To further implement the system 10, application software 260 must be provided that is compatible with the workstation 240. This application software 260 is generally shown in FIG. 31. Although the various functional blocks of the application software 260 are shown in modular form in FIG. 31 as a matter of convenience and clarity, there is no requirement that the software be written or structured in separate modules. Those of skill in the art will recognize that the application software, as further described below, can be written in a variety of programming languages and can comprise pre-existing conventional software tools that are customized or combined with other code as described to implement the novel functionality as described herein. For example, in one embodiment of the system 10, a simulation design is entered by using a custom drawing tool created using the Domain Modeling Environment (DoME). DoME was developed by Honeywell to aid in the prototyping and development of graphical tools and specifications. It supports the execution of Alter methods that can be used to enforce design rules and create artifacts such as code and documentation.

Thus, in accordance with one embodiment of the invention, the application software 260 will include graphical user interface module 271, node module 272, arc module 273, parameter data module 274, and output file module 275. Although the application software 260 is represented as being physically separate from the components of the workstation 240, again for purposes of clarity, the software itself will typically be resident in non-volatile memory associated with CPU 251, such as data storage device 256, from where the software 260 can functionally interact with CPU 251 and operating system 252.

In a preferred embodiment of the system 10, GUI module 271 in cooperation with operating system 252, will generate a GUI having a “windows” structure. The node module 272 and arc module 273 will provide further definition to the GUI by generating the novel sets of pre-defined node and arc elements of the system 10 as described below.

The application software 260 further includes a parameter data module 274 to enable the user, through a data window within the GUI, to input parameter data to further define the real-system component representations (node elements) and real-system functional relationship representations (arc elements). Output file module 275 functions in association with operating system 252 to store simulation architecture data files on data storage device 256, such files containing data representing selected node and arc elements, and parameter data, in their user-selected arrangement and definitions. Output file module 275 also generates an output file containing pre-defined portions of the simulation architecture data files, where the output files are electronic output files that can be used for generating computer code that defines a computer simulation corresponding to the architectural description created by the user on computer workstation 240.

Graphical Node Elements

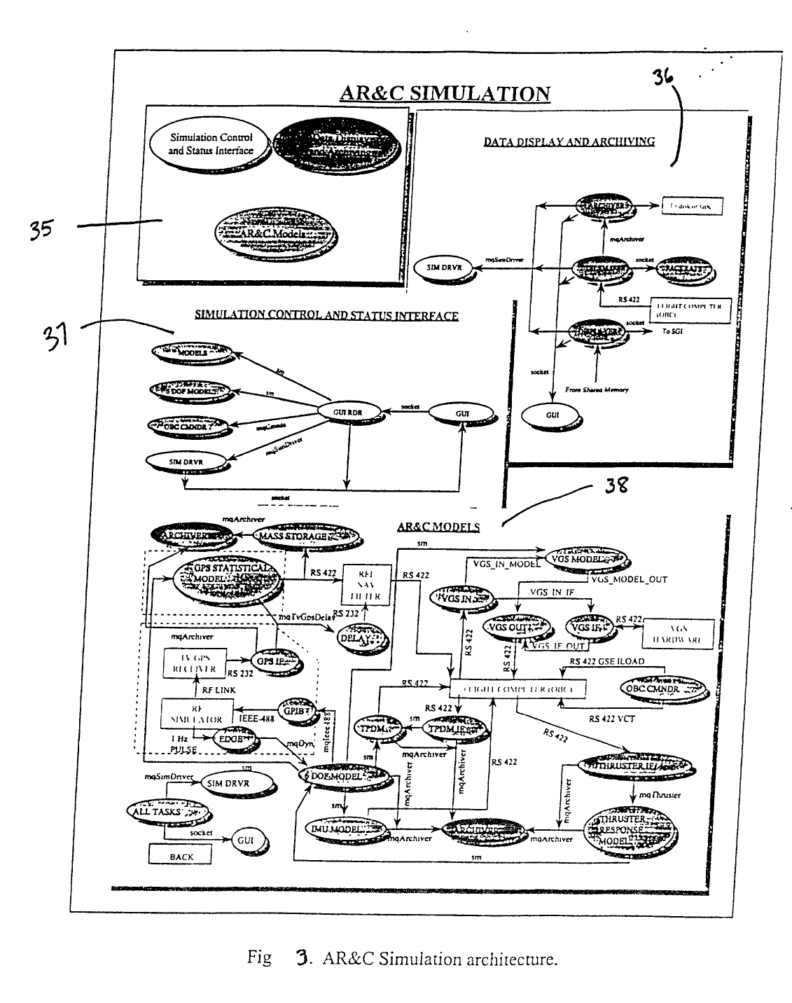

In accordance with one novel feature, the system 10 can graphically describe simulation components associated with a real-world system, including either hardware devices or simulation software. These components are represented by a standardized set of pre-defined graphical node elements generated by node module 272. Graphically, different node types are differentiated by shape, as shown in FIG. 4. External hardware devices are represented with a triangle node 44. There are many different types of hardware components that can be used in a simulation. However, their internal behavior is abstracted, and they are all considered as black boxes by the simulation and by the system 10. As a result, all hardware devices are represented using the same node type.

Simulation software is represented by three different types of nodes that differentiate the types of processes supported by this simulation model. Again looking at FIG. 4, each periodic process node is represented using a circle 40. Each aperiodic process node is represented using two concentric circles 41. Each continuous process node is represented as three concentric circles 42. As further described below, the system 10 allows for the specification of non-functional properties of all three types of processes, including execution time, frequency, processor upon which to execute, and other information used to support allocation and scheduling.

In a preferred embodiment of the system 10, two additional node types are defined: simulation containers and boundary nodes. The simulation container is drawn as a rectangle 43 and can represent an arbitrary collection of node and arc elements. The boundary node is drawn as a diamond 45 and represents the interface to an arbitrary set of arc elements as defined below. Simulation containers 43 and boundary nodes 45 are used for abstraction purposes allowing the designer to implement hierarchical designs with varying levels of abstraction.

Graphical Arc Elements

Real-time simulations involve timing relationships that can be very complex. There are specific time dependencies among the simulation components that may include a pre-defined order of execution among the simulation software. In addition to the timing relationships, there are data dependencies among the components as well. In order to capture the high-level architecture of such a simulation, all of these relationships must be represented accurately. Accordingly, the system 10 uses directed arc elements to connect the nodes in a manner that represents the data flow, control flow, and timing relationships between and among the simulation components, or nodes. The arc types include a communication container, a data transfer, a synchronization (sync), and a synchronization-with-data (sync-with-data).

The communication container is used for abstraction purposes. It can contain an arbitrary collection of arcs in order to abstract communications for high-level diagrams. The remaining arcs are used to represent the details associated with communicating nodes. Further details describing each arc element associated with data, sync, and sync-with-data communications between the various types of nodes are provided below.

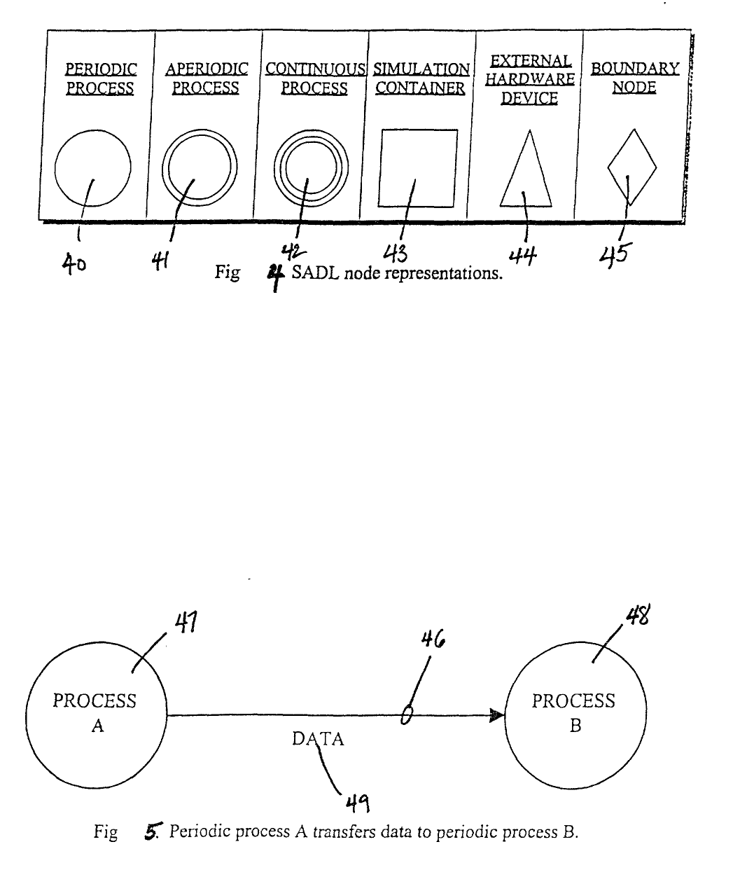

Referring to FIG. 5, an arc 46 representing a data relationship connects two graphical nodes 47 and 48. Specifically, arc 46 represents a data transfer from graphical node 47 to graphical node 48. Arc 46 is noted as a data transfer by its appearance (such as line color or line style in a preferred embodiment) and is further described by the presence of an arc definition string 49, which gives additional information regarding the relationship graphically represented by the arc. This type of data relationship is very common in simulations where a global data repository is shared among the process set. This relationship means that process A (node 47) produces some data that process B (node 48) consumes. There is no implied order of execution for the two processes involved, and there is no restriction on the invocation rates of either process. Process A produces the data, and process B consumes the data when it is needed. If process A has not updated the data when process B consumes it, then process B proceeds using old data. Similarly, if A updates the data multiple times between reads of the data by process B, then B uses only the latest data. It is assumed that the critical regions of each process reading from and writing to a shared memory are protected using semaphores or spinlocks in order to provide mutually exclusive reads and writes of the data. Although FIG. 5 shows a data transfer between two periodic processes, the semantics of the data transfer are the same for any types of nodes interconnected with a data arc.

The behavior of processes that are synchronizing is much more complex. Collaborative synchronization methods involving several processes such as barriers are not supported by the system 10. All synchronizations are point-to-point communications between two processes that are connected with a sync arc or a sync-with-data arc. The general meaning associated with this relationship is that the source process executes first, provides a synchronization mechanism to the destination process, and then the destination process can execute. The synchronization mechanism is the trigger for the execution of the destination process, and the destination process blocks or polls while waiting for the synchronization mechanism.

The sync and sync-with-data arcs have two properties that help define the relationship between the processes connected. The first property is the release time of the synchronization relative to the execution cycle of the source process. The execution cycle is the time a process executes for each of its invocations. Therefore, the release time is the time within the execution cycle of the source process that the synchronization is sent to the destination process. The synchronization mechanism can be sent at the beginning or the end of the execution cycle. Sending it at the beginning of the cycle allows the destination process to begin approximately at the same time as the source process, thus parallelizing the execution of the source and destination processes. Sending it at the end of the execution cycle means that the destination process must wait for the source process to complete execution before it can begin. In effect, this serializes the execution of the source and destination processes.

The second property required for a sync or sync-with-data arc is the frequency. This property represents the frequency at which the source process sends the synchronization mechanism to the destination process. There are two distinct value ranges for the frequency. A positive frequency value means that the synchronization occurs at the frequency specified by the positive value. A frequency value of zero means that the synchronization occurs aperiodically.

The specific behavior of two periodic processes synchronizing depends upon the frequencies at which these processes are invoked and the frequency at which the synchronization mechanism is transmitted between the processes. The release time of the synchronization mechanism only controls the serialization or the parallelization of the execution of the processes and does not change the underlying semantics involved with the synchronization.

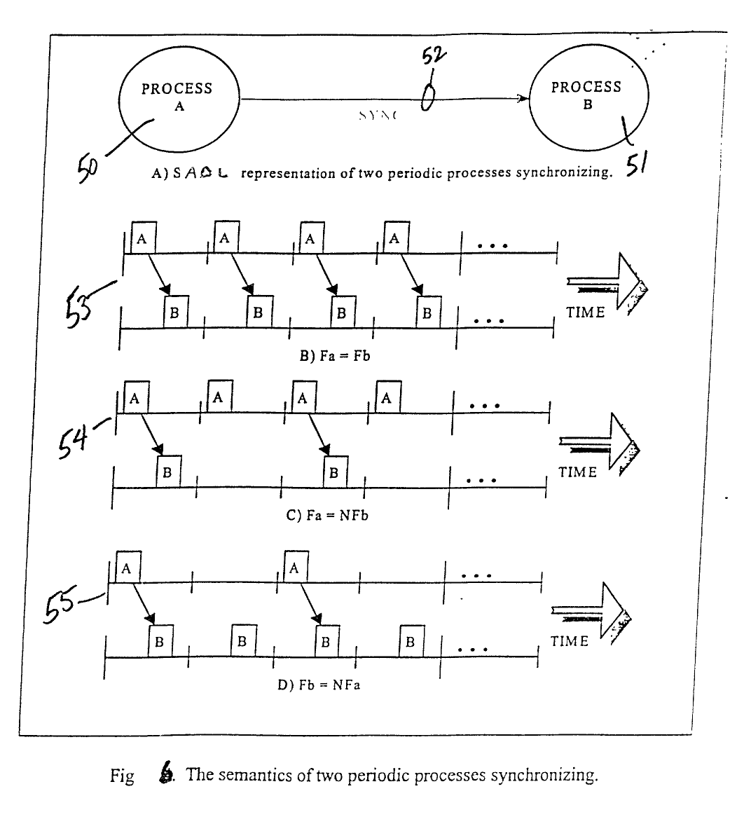

In FIG. 6(A), two periodic processes A (node 50) and B (node 51) with frequencies Fa and Fb, respectively, are shown connected by a sync arc 52. One possible relationship is for Fa to equal Fb and the processes A and B to synchronize during every invocation. This relationship represents two processes executing in lock-step fashion, which is commonly seen in producer-consumer applications. Since processes A and B execute at the same frequency and every invocation of process B must synchronize with every invocation of process A, the frequency of the synchronization mechanism, Fs, is equal to Fa and Fb. Thus, process A generates the synchronization mechanism during each of its execution cycles, and process B is invoked when it receives the synchronization mechanism. FIG. 6(B) shows the resulting execution timeline 53. FIG. 6(B) assumes that the synchronization release time is the end of process A's execution cycle thus serializing the execution of processes A and B.

A second possible relationship occurs if Fa is greater than Fb and process B must synchronize with process A each time process B is executed. Because of the requirement that all periodic processes in a simulation must have frequencies that are harmonics of one another, Fa must be an integer multiple of Fb. Since B synchronizes with A every time B executes, Fs is equal to Fb. This relationship is common in situations where one process must collect data at a very high rate and filter it before sending it to a process executing at a slower rate. This requires process A to contain the logic necessary to provide the synchronization mechanism to process B at the correct frequency. This relationship is shown in execution timeline 54 in FIG. 6(C) where Fa is twice Fb. FIG. 6(C) assumes that the sync mechanism has a release time corresponding to the end of the execution cycle of process A.

In the case in which Fb is greater than Fa, and B must synchronize with A each time A is executed, then Fb must be an integer multiple of Fa. Process A executes at its frequency and sends a synchronization mechanism to process B during each execution cycle. That is, Fs is equal to Fa. Process B executes more often than A and requires the use of a system clock and internal timing logic in order to control its own invocation rate. However, process B must also synchronize with process A every N invocations. Such a relationship is often used to synchronize timers from two computer systems to accommodate for clock skew. This relationship is shown in execution timeline 55 in FIG. 6(D), where process B synchronizes with process A every two invocations of process B. In FIG. 6(D), the release time of the synchronization mechanism is the end of the execution cycle of process A.

Several points need to be made regarding these relationships as described by the system 10. First, there are many more possible relationships among Fa, Fb, and Fs than addressed above. However, the cases discussed above constitute those that are nearly always encountered within the defined application domain. Also, in a preferred embodiment, the system 10 enforces the semantics described above and will not allow improper arc connections between nodes to be made. For example, it is not legal for two periodic processes to be connected using a synchronization mechanism that is aperiodic in nature. Also, the semantics described in FIG. 6 can be extended to include periodic processes interconnected with a sync-with-data arc. The only difference is that the processes synchronize and pass data instead of just synchronizing. Finally, a single graphical representation can represent several different execution relationships. The same nodes and arc in FIG. 6(A) represent three different execution relationships. In order to determine the exact execution characteristics of the processes, the properties of the processes and the arcs must be examined.

FIG. 7(A) illustrates the case involving a periodic process synchronizing an aperiodic process. An example of such a relationship is a periodic process representing the dynamics of a vehicle sending data to an archiving process that can only execute upon the receipt of the synchronization mechanism accompanying the data. FIG. 7(A) shows an aperiodic process B (node 61) that requires synchronization (arc 64) from a periodic process A (node 60). By definition, execution of an aperiodic process is dependent upon some external event or condition that occurs aperiodically. In this case, that external event or condition is the synchronization from process A. Process A must contain all the logic necessary in order to send the synchronization to process B at the appropriate times. Process B simply blocks waiting to receive the sync from process A. The sync must have a frequency of zero indicating that it is aperiodic in nature. FIG. 7(B) shows the execution timeline 63 for this case. It assumes that the sync is released at the end of the execution cycle of process A. The sync can also be used to parallelize the execution of both processes by assigning it a release time at the beginning of the execution cycle of process A.

The case of an aperiodic process sending a synchronization mechanism to a periodic process is considered illegal by the system 10 and is not allowed. An aperiodic process is not capable of generating a periodic synchronization mechanism.

FIG. 8(A) shows an aperiodic process A (node 65) synchronizing (arc 67) another aperiodic process B (node 66). The frequency of the synchronization mechanism must be set to zero to indicate that it is aperiodic. During execution, process A decides whether or not to send the synchronization to process B. Process B blocks on the synchronization mechanism from A entering the ready queue when it is received. There is no regular pattern established regarding the execution of A and B. Process A executes aperiodically based upon its external dependencies, and B executes upon receiving the synchronization from A. FIG. 8(B) shows the execution timeline 68 for this relationship assuming that the synchronization release time is set to the end of the execution cycle of process A.

Continuous processes behave differently than do periodic or aperiodic processes. They begin execution at the beginning of the simulation, and they busy wait while testing for events or conditions as opposed to blocking. As a result, they never relinquish the processor, and they execute for the entire duration of the simulation. The receipt of a synchronization does not change the state of the process from blocked to ready. Instead, it changes only the control flow through the process. Also, the release time of a synchronization from a continuous process must be at the beginning of its execution cycle. Continuous processes are only invoked once and execute until the end of the simulation. All other processes in the process set must execute in parallel with them.

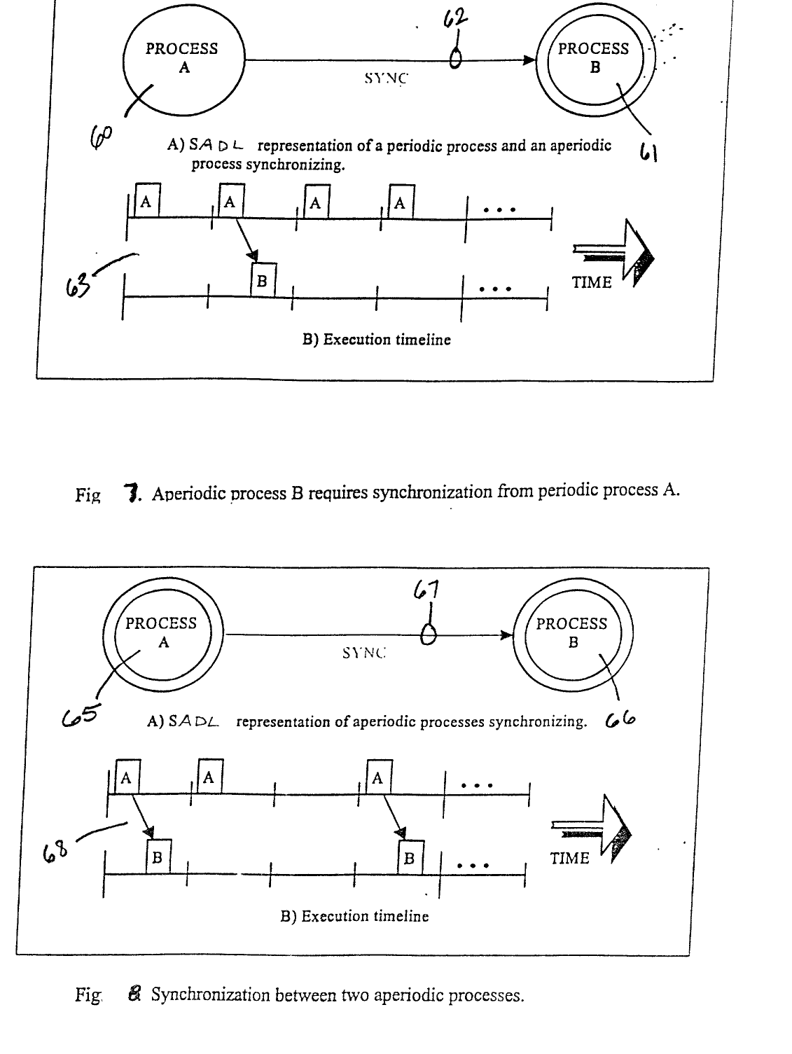

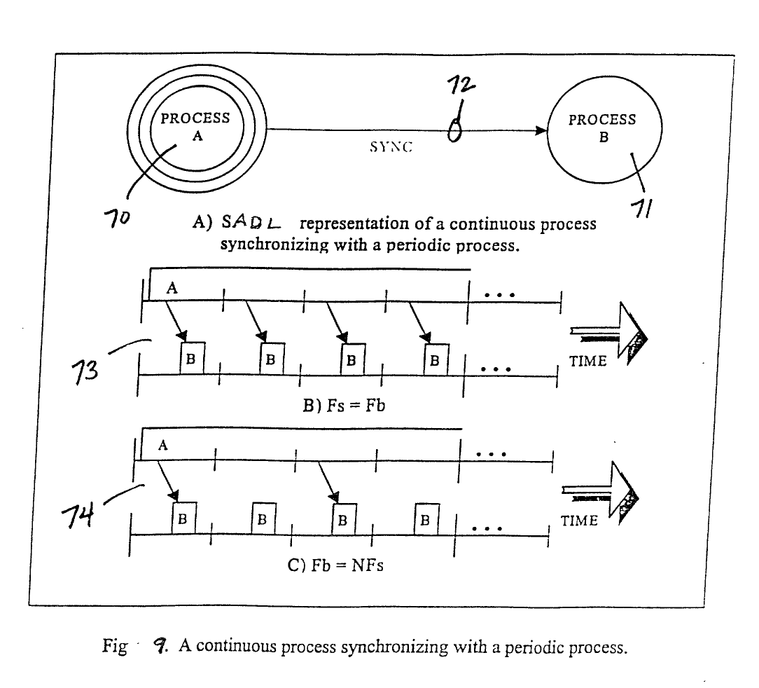

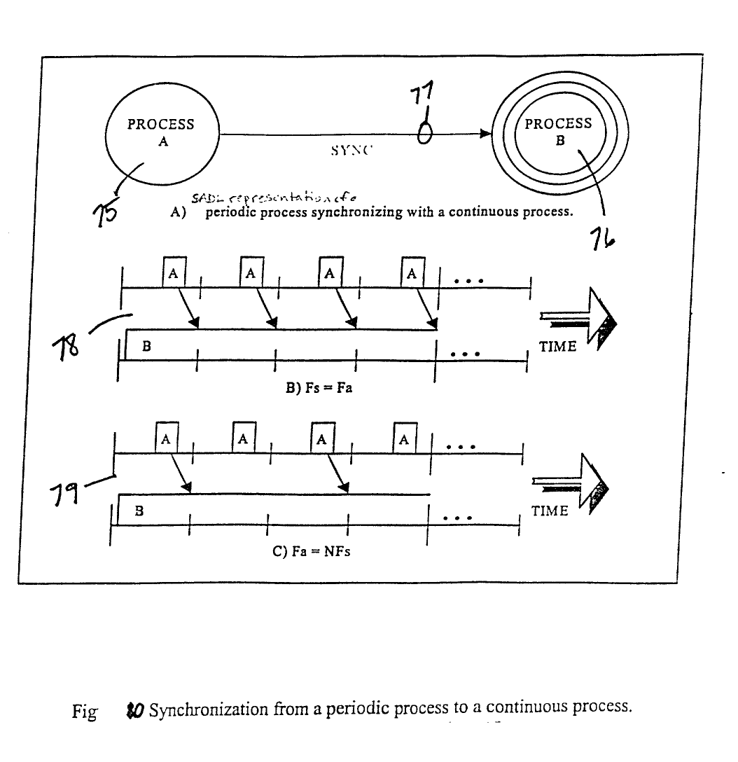

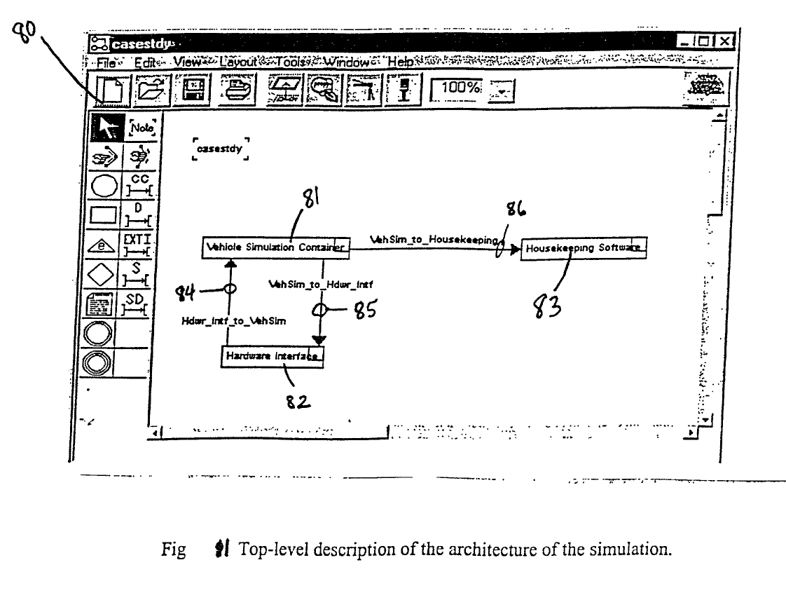

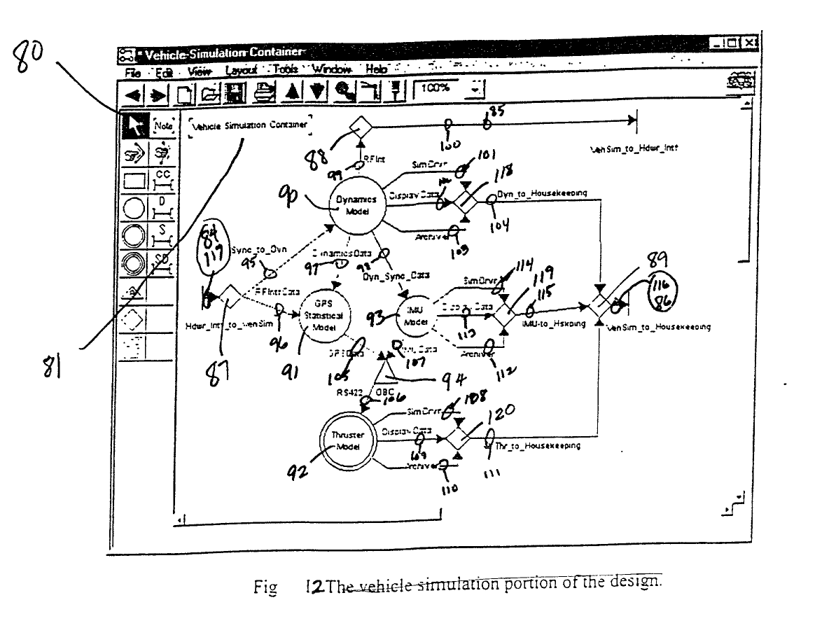

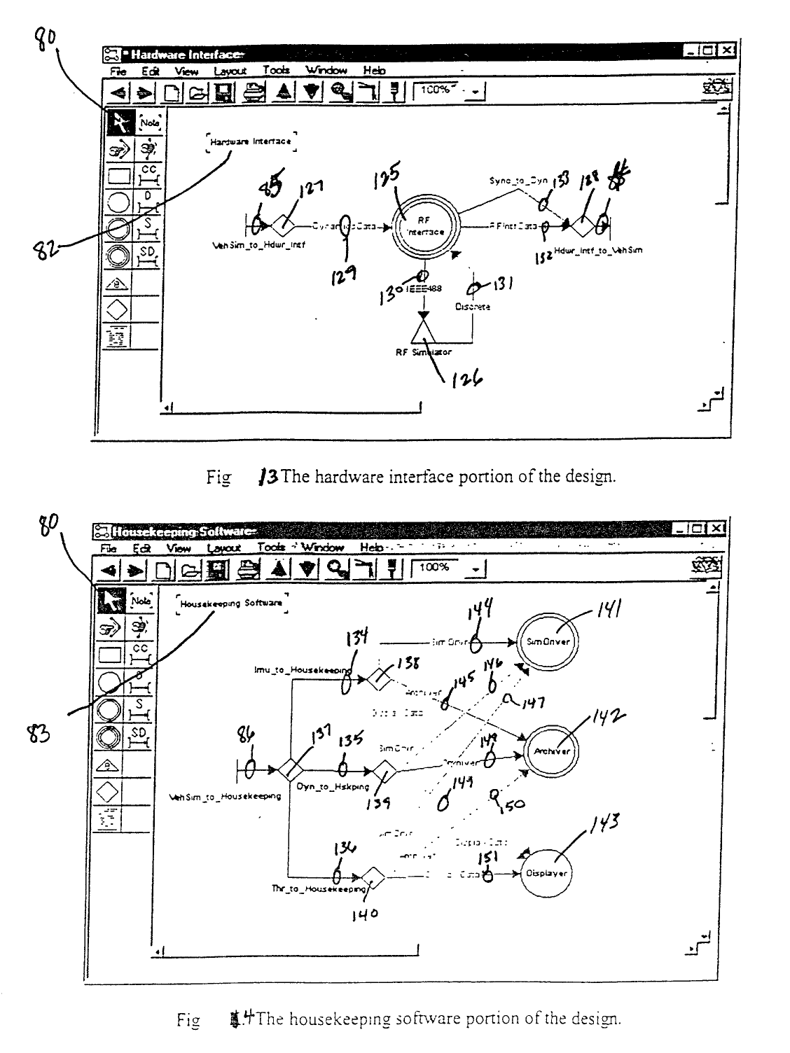

The semantics of synchronizations involving continuous processes are very similar to those involving the other types of processes since continuous processes model the same periodic and aperiodic behavior in the simulation as the other processes but with a different implementation. Consider a continuous process A (node 70) sending a sync (arc 72) to a periodic process B (node 71) as shown in FIG. 9(A). Let Fb represent the frequency of execution for process B. If process B requires a synchronization from process A during every execution cycle, process A must send the synchronization mechanism at the same frequency as Fb. That is, Fs is equal to Fb. This is shown on execution timeline 73 in FIG. 9(B). A second relationship occurs when process B has an invocation rate faster than the required synchronization rate with the continuous process. The continuous process sends the synchronization mechanism at its required rate, and the periodic process receives it every N invocations. This is shown in execution timeline 74 of FIG. 9(C), where Fb is twice that of Fs. These relationships produce nearly the same behavior as those involving two periodic processes as seen in FIGS. 6(B) and 6(C).

If the source process is a continuous process and the destination process is an aperiodic process, the synchronization mechanism is aperiodic, represented by a frequency equal to zero. The continuous process generates the sync mechanism at irregular intervals based upon some internal logic, and the aperiodic process blocks until receipt of the synchronization.

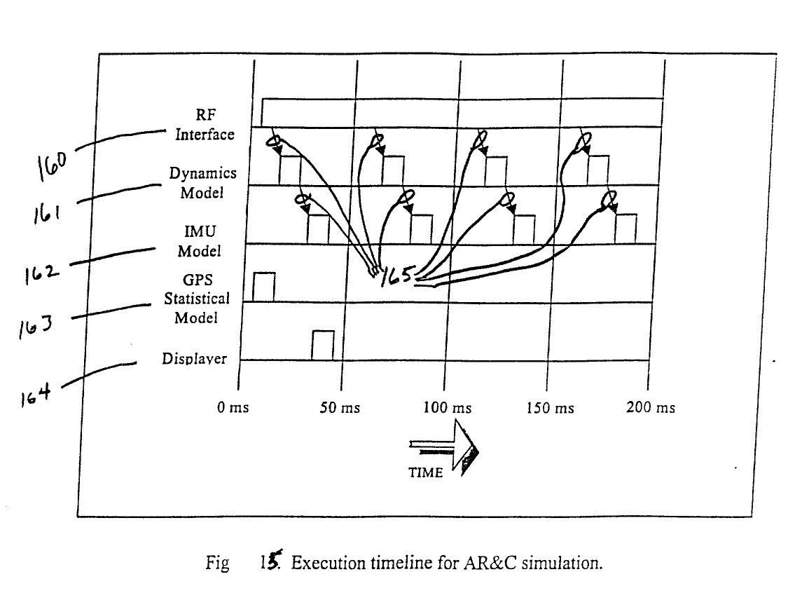

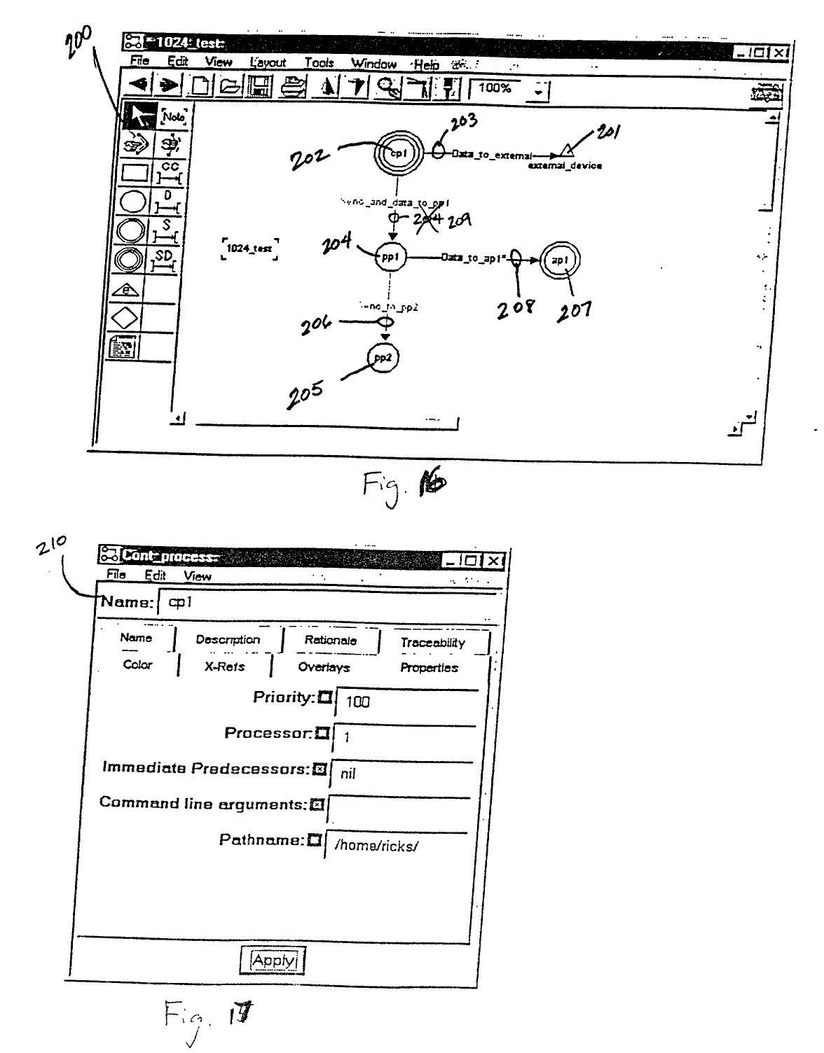

Continuous processes can also receive synchronizations from periodic and aperiodic processes. If the source process is aperiodic, then the synchronization must be aperiodic also. If the source process is periodic, there are two relationships of interest. The synchronization (arc 77) from a periodic process A (node 75) to a continuous process B (node 76) is shown in FIG. 10(A). The first relationship is when the source process generates the synchronization mechanism at a frequency equal to its invocation rate, Fs is equal to Fa. In this case, the continuous process requires a synchronization from each invocation of the periodic process. The execution timeline 78 for this relationship is shown in FIG. 10(B). The second case occurs when the source process generates the synchronization at a frequency less than its invocation rate. Specifically, Fa is an integer multiple of Fs. This represents a situation in which the continuous process requires a synchronization from the periodic process every N invocations of the periodic process, as shown in execution timeline 79 in FIG. 10(C). In both cases, the continuous process simply polls for the synchronization mechanism. It is the responsibility of the continuous process to verify that all synchronizations are recognized and that none are missed due to polling activities for different events or due to computational activity.

In the case of one continuous task sending a sync to another continuous task, the sync can be aperiodic or periodic. The behavior of the destination process is simply to poll for the syncs.

Despite their obvious differences, an external device behaves the same as a continuous process when considering its interaction with other simulation components using a sync or a sync-with-data arc.

Finally, one more issue involving synchronization needs to be discussed. This issue deals with how multiple synchronization arcs into a single process (node) are handled. Some existing tools provide a means of combining execution constraints using logical OR operations and logical AND operations. However, the present system 10 implements an OR operation by allowing multiple synchronization arcs into an aperiodic process or a continuous process only if the same synchronization mechanism is used for all such arcs. For example, a process can receive a synchronization via a signal from multiple source processes as long as a signal is used for every synchronization. This allows the destination process to wait for one mechanism and begin execution on the first occurrence of the mechanism regardless of its source. If a signal and a message queue were used to synchronize the same process, the blocking or polling strategies of the destination process would be complicated considerably. The system does not support more than one synchronization arc into a periodic process. The reason for this is due to complexities introduced such as clock skew that affect the execution of the destination process.

Creation of the Architectural Description

FIG. 32 is a flowchart describing operation of the system 10 to create a visual description of a simulation architecture. As a first step (300), a user boots computer workstation (240 in FIG. 31). The user next (301 and 302) loads and begins to run the application software (260 on FIG. 31) necessary to practice the preferred embodiment of the invention.

Further referring to FIG. 32, a user decides (303) whether to work with an existing simulation description file (304) or to create a new simulation description (305). If the user decides to create a new simulation description, the system application software 260 is invoked, and the user is thus enabled to use all of the tools of the invention to visually describe a simulation architecture.

At this point in the method of the invention, the user iteratively arranges (306) nodes and arcs to describe the desired simulation architecture, and specifies properties (307) relating to those nodes and arcs. When the user is satisfied with the arrangement of nodes and arcs, the user may exit (308) the iterative process, save the design (309) in a simulation architecture data file and exit the design phase (310) of the system by any conventional means.

The present invention may also be described as a method having the following steps. First, a user selects at a graphical user interface one or more graphical node elements from a standardized set of graphical node elements displayed at the workstation. The user then selects at the graphical user interface one or more graphical arc elements displayed at the workstation. The user arranges the graphical node and arc elements to create and display on the workstation the architectural description of the simulation of a real system. The user then enters parameter data at one or more parameter data input windows associated with at least some of the selected node and arc elements to further define properties of the selected node and arc elements found in the real world system. The user is then enabled to save data relating to the user-defined selection and arrangement of the node and arc elements and parameter data input windows as input by the user.

Use of the system 10 to create an architectural description of the simulation conventionally described in FIG. 3 is illustrated in FIGS. 11-14. FIG. 3 shows an example of a prior art description of an Automated Rendezvous and Capture (“AR&C”) simulation architecture that might be used in simulating an orbiting spacecraft as it docks with an orbiting space station. Such a simulation is extremely complex and requires many resources to perform, yet there is a proportional relationship between the intricacy of the simulation and the quality of the simulation.

FIG. 11 shows one embodiment of a graphical user interface (GUI) window 80 generated by GUI module 271 (FIG. 31). Positioned along the left margin of the GUI window 80 are the standardized sets of node and arc elements. The left portion of the GUI window 80 provides access to the drawing tools. The nodes are arranged in a set in the left column and the arcs are arranged as a set in the right column. The right portion of the GUI window 80 is the drawing pane where the architecture is actually constructed. Through graphical user interface 80, a user may select any of a plurality of graphical node elements and graphical arc elements, and the user may arrange such graphical node and arc elements to visually describe the simulation of the real system.

Graphical user interface 80 also contains a basic set of rules that are applied to every simulation description. The basic set of rules in the application software 260 (FIG. 31) tests the relationships defined by selected arcs and nodes to ensure that the user does not attempt to create an illegal relationship in the simulation architecture. Although the following list is not exhaustive, examples of attempts to create such illegal relationships include: connecting a periodic source process to a periodic destination process with an aperiodic synchronization relationship; connecting an aperiodic source process to an aperiodic destination process with a periodic-type synchronization relationship; and connecting a single process with multiple relationships defining different synchronization relationships. Other simulation architecture rules may be defined in downstream tools outside the present invention to evaluate simulation architecture designs as well.

The simulation described in FIG. 11 is broken into three sections, a vehicle simulation section (container node 81), a hardware interface section (container node 82), and a housekeeping software section (container node 83). This decomposition is different from that shown in FIG. 3. Each section is represented using a simulation container, and the interconnections (arcs 84, 85, and 86) between the container nodes 81, 82, and 83 are abstracted by the use of communication containers. The goal of this type of high-level diagram is to provide a design overview by hiding the details.

Each of the simulation containers in FIG. 11 contain a sub-diagram showing all the details associated with the components that make up that section of the design. The contents of the vehicle simulation container 81 are shown in FIG. 12. The hardware interface container 82 is shown in FIG. 13, and the housekeeping software container is described in FIG. 14. In each section, the nodes and the arcs representing the actual simulation architecture are shown. As described earlier, the node types are distinguished by shape. The arc types are distinguished by color. Abstractions are still used at this level to mitigate the clutter that appears in each editing pane. For example, multiple input or output arcs from a single node are abstracted into one communication container, drawn in black. The boundary nodes (the diamond-shaped nodes) represent the interface between a communication container and its contents. All of the arcs that enter or leave one section of the design are represented at the left and right edges of the window as boundary points and appear in the connecting section's window as boundary points as well.

Now consider the execution characteristics of the simulation processes specified in this example. There is one continuous process, the RF Interface (node 125) that is located in the Hardware Interface subsystem (FIG. 13). This process executes on its own processor and sends a sync every 50 ms to the Dynamics model (node 90) in the Vehicle Simulation subsystem (FIG. 12). The Dynamics model is in the group of periodic processes, which also includes the IMU model (node 93), the GPS Statistical model (node 91), and the Displayer (node 143 on FIG. 14). Each of these processes executes within a major and minor frame environment established on the host computer, as shown on execution timelines 160-164 in FIG. 15. The major frame is 200 ms and is comprised of four 50 ms minor frames. These times are derived from the frequencies of the periodic processes. The Dynamics model (timeline 161) executes every 50 ms and must block waiting for the sync from the RF Interface process (timeline 160) before each of its invocations. The frequency of this sync is 20 Hz, and its release time must be at the beginning of the execution cycle since the RF Interface task is continuous. Upon receipt of this synchronization, the Dynamics process executes and provides a sync-with-data to the IMU model at a frequency of 20 Hz with a release time at the end of the Dynamics process execution cycle. The IMU model (execution timeline 162) also executes at 20 Hz and blocks while waiting for the synchronization mechanism from the Dynamics model (execution timeline 161). Therefore, every invocation of the IMU model is serialized with an invocation of the Dynamics model via this synchronization mechanism, and every invocation of the Dynamics model must synchronize with the RF Interface process. This relationship is shown in FIG. 15.

The GPS Statistical model (node 91) and the Displayer process (node 143) are also periodic, but they have no synchronization dependencies. These processes, which each execute at 5 Hz, (timelines 163 and 164) must contain the logic necessary to control their own invocation rates by interfacing with the operating system. In this example, both processes must execute once every major frame. For purposes of simplicity, they are shown executing in the first minor frame of each major frame.

There are three aperiodic processes in the simulation. They are the SimDrvr process (node 141 on FIG. 14), the Archiver process (node 142 on FIG. 14), and the Thruster model (node 92 on FIG. 12). The Thruster model has one input, a sync from the on-board computer (OBC). It blocks on this sync and is scheduled for execution sometime after its receipt. Sync-with-data arcs are used for communication from the Dynamics model, the IMU model, and the Thruster model to the SimDrvr and Archiver processes. These two processes only enter the ready queue upon the receipt of the sync mechanism from one of the models. These syncs are released at the end of the execution cycle of the models thus serializing the execution of the models and these aperiodic processes. In cases where multiple syncs are inputs to the same node, all of the source processes contributing a sync must use the same sync mechanism. In other words, the destination process will block on a single sync mechanism, and the source processes are merely sending different instances of the same sync mechanism. In this way, the syncs are logically OR'd by the destination process.

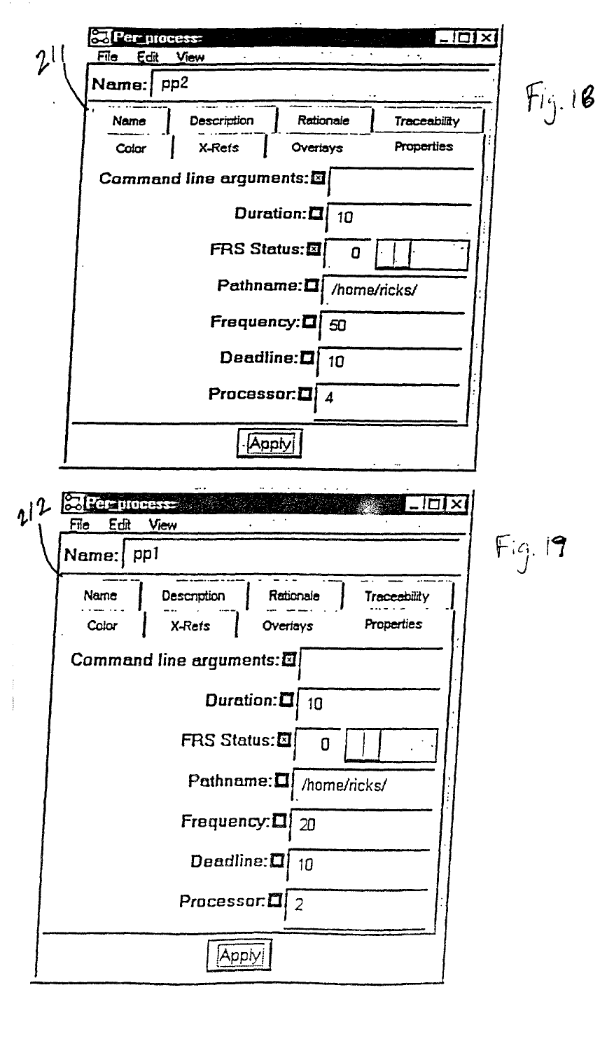

A further example of an embodiment of the invention is illustrated in FIGS. 16 through 29. Referring to FIG. 16, graphical user interface 200 is used to allow a user to arrange a plurality of graphical node and arc elements to create a visual description of the architecture of a computer simulation of a real system. Graphical user interface 200 contains all of the instrumentalities needed to graphically describe such a simulation and allows the user to exploit the functionality of the invention.

Within graphical user interface 200 in FIG. 16 can be seen a plurality of nodes connected by a plurality of arcs to form the visual description of a particular simulation. One of the outputs of the simulation will be seen to be an external hardware device graphically symbolized by node 201. Node 202 graphically represents a continuous process within the simulation description. The relationship between node 202 and external hardware node 201 is symbolized by arc 203, which represents data passing from node 202 to node 201. Node 204 represents a periodic process that is related to node 202 by arc 209. Arc 209 represents a timing and data relationship between node 204 and node 202. Node 205 represents a periodic process that is related to node 204 by arc 206. Arc 206 represents a timing relationship between node 204 and node 205. The direction of the arrow indicates the flow of the timing, data, and control relationship. Node 207 graphically represents an aperiodic process that is related to node 204 by arc 208. Arc 208 represents a data transfer from node 204 to node 207.

Input of Node Parameter Data

FIG. 17 is a view of a parameter data input window 210 associated with node 202 in FIG. 16. A parameter data input window is a feature of the graphical user interface that allows the user to associate further-defining parameter data to a node or an arc via the workstation. The parameter data input window thus gives the user the ability to assign highly specific information to a node or an arc. While the user can view the information on demand, nodes and arcs will usually be viewed in their abstract graphical form, so that the invention's objective of hiding details will be achieved.

Referring to FIG. 18, parameter data input window 211 is associated with node 205 in FIG. 16. Parameter data input window 211 allows the user to select and input via the workstation a plurality of parameter data further defining node 205. Since each parameter data input window is user-defined to correspond with the graphical element that the parameter data input window describes, the data types displayed in FIG. 18 are merely exemplary.

Nevertheless, parameter data input window 211 allows the user to define the following data parameters with respect to node 205 in FIG. 16: process name, process description, rationale for the process, traceability of the process, color of the process' depiction, cross-references to other processes, and process overlays. These data may be defined for any node or arc in the simulation. Additionally, a user may define the following properties of node 205, specific to periodic processes in the simulation: command line arguments, duration, FRS status, path name, frequency, deadline, and processor. Some of the above parameters are general, while some of the parameters are specific to periodic processes.

The parameter data input window associated with a particular node or arc may be accessed by selecting the node or arc of interest via a pointing device such as a mouse at a computer workstation. One possible way of performing this task is by using a pointing device to point a cursor generated on the display of the computer workstation at the node or arc of interest, then double-clicking a button on the pointing device. This causes the computer workstation to display the parameter data input window associated with the node or arc of interest. However, any method or process by which a user selects a node or arc with a view to accessing the node's or arc's parameter data input window is suitable.

Referring again to FIG. 16, a parameter data associated with a node or an arc in FIG. 16 is accessed through graphical user interface 200 of FIG. 16 by selecting the node or arc of interest in graphical user interface 200. Any node or arc can have a plurality of user-defined quantities associated with the node or arc. This capability allows the user to completely define a node or an arc, while at the same time abstracting those quantities from the graphical views of the node or arc. Abstracting the parts of a simulation makes simulation organization easier to comprehend, and makes the implementation details irrelevant to a top-level analysis of the simulation architecture.

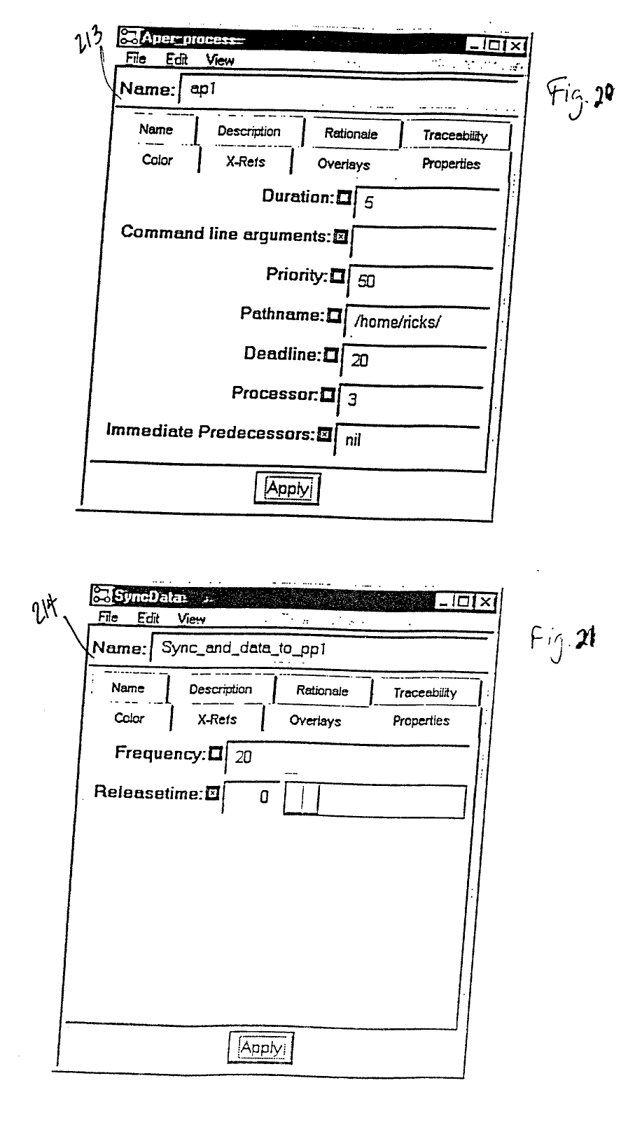

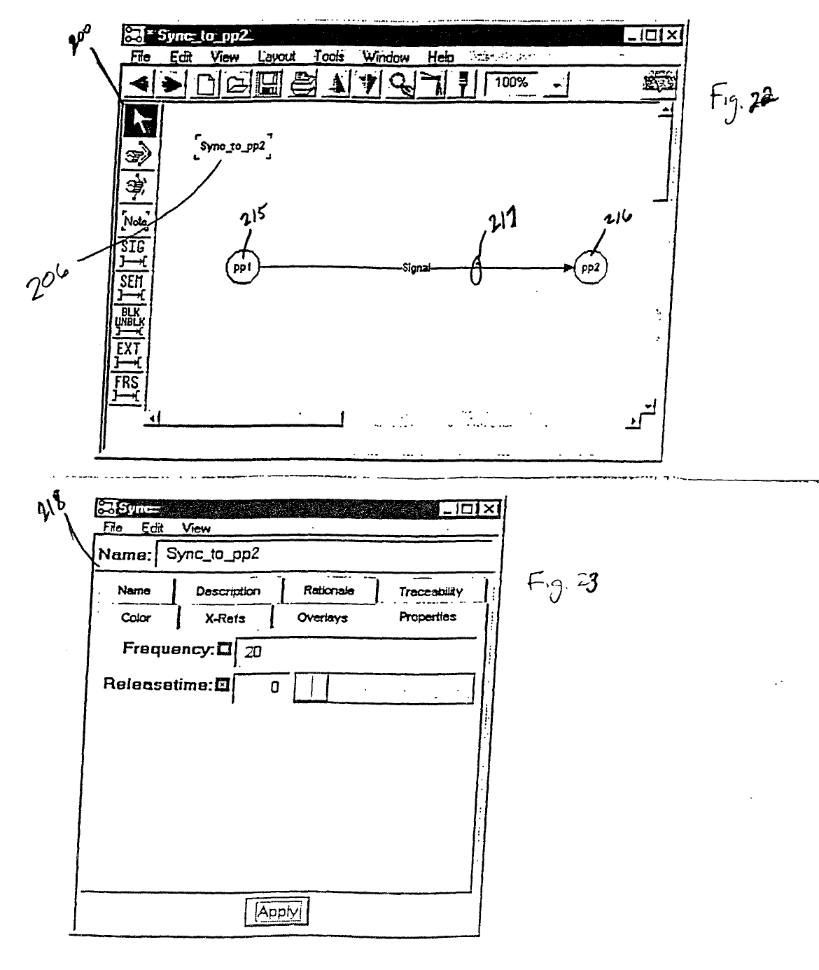

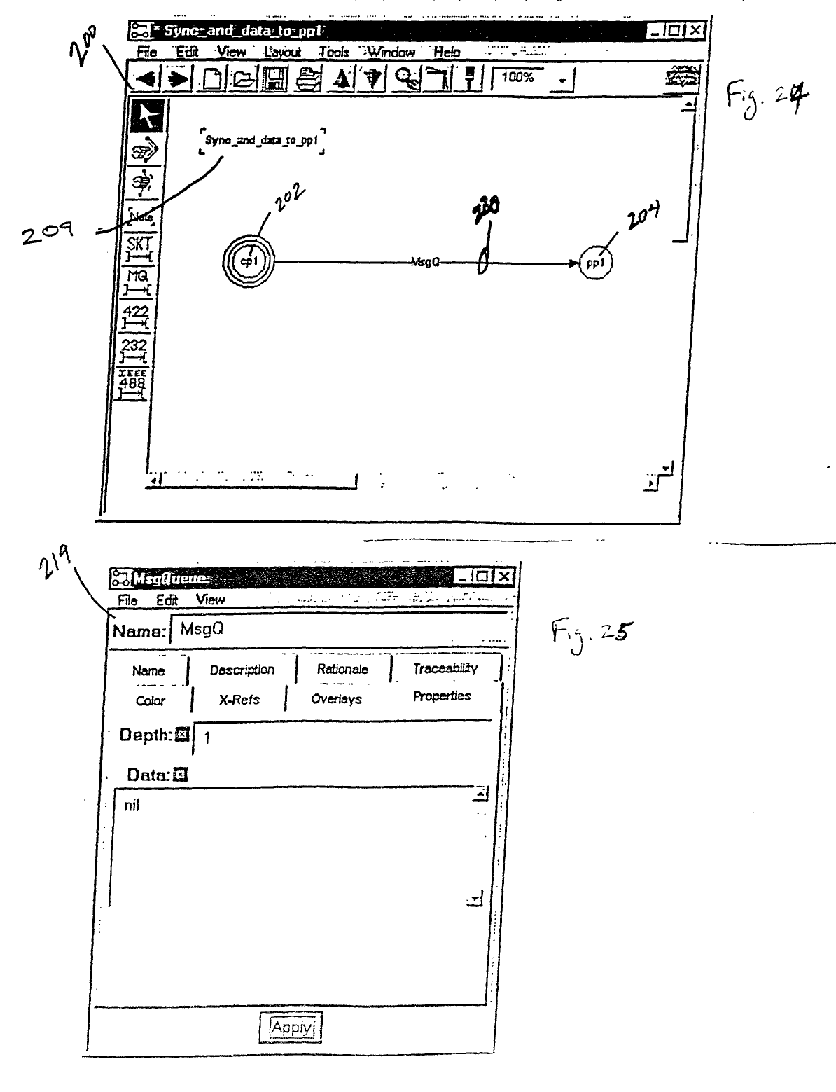

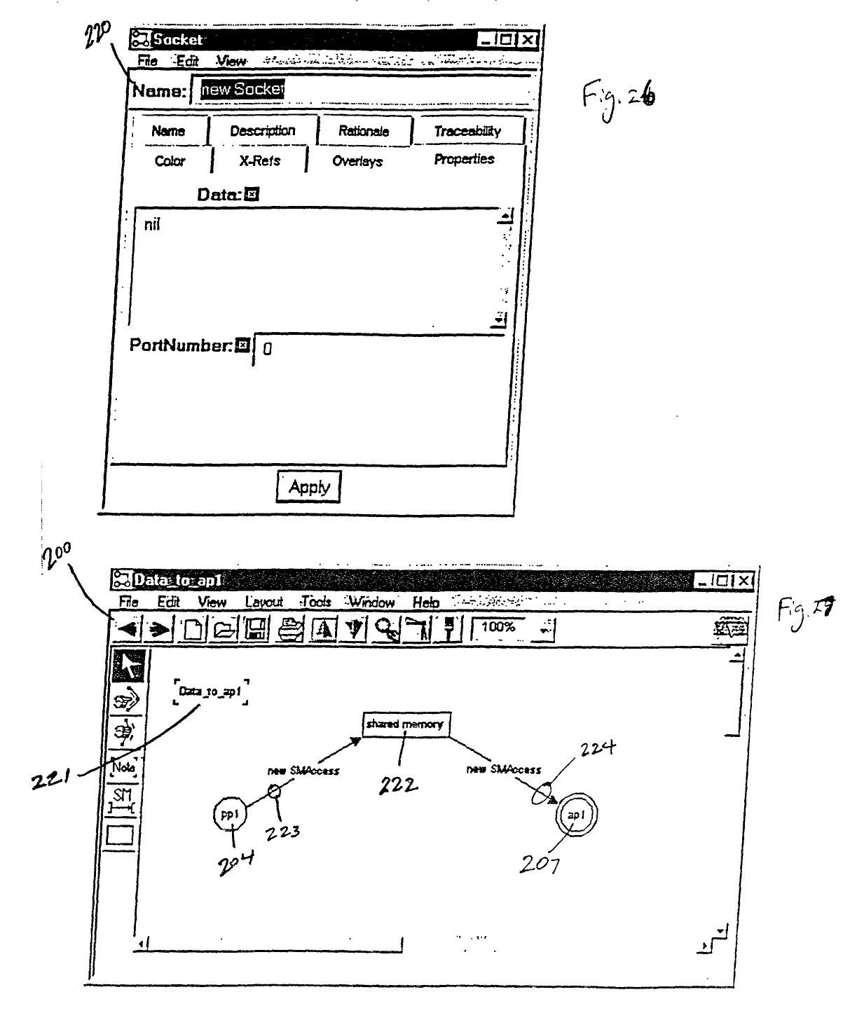

FIG. 19 depicts parameter data input window 212, through which the user may input parameter data via a computer workstation to further define node 204 in FIG. 16. The possible implementation details in parameter data input window 212 are the same as the possible implementation details of parameter data input window 211 in FIG. 18, because both figures are associated with periodic processes. As previously discussed with respect to parameter input data window 211, parameter data input window 212 permits implementation details of node 204 to be defined thereby, while at the same time keeping those implementation details separate from the graphical representation of the simulation architecture.

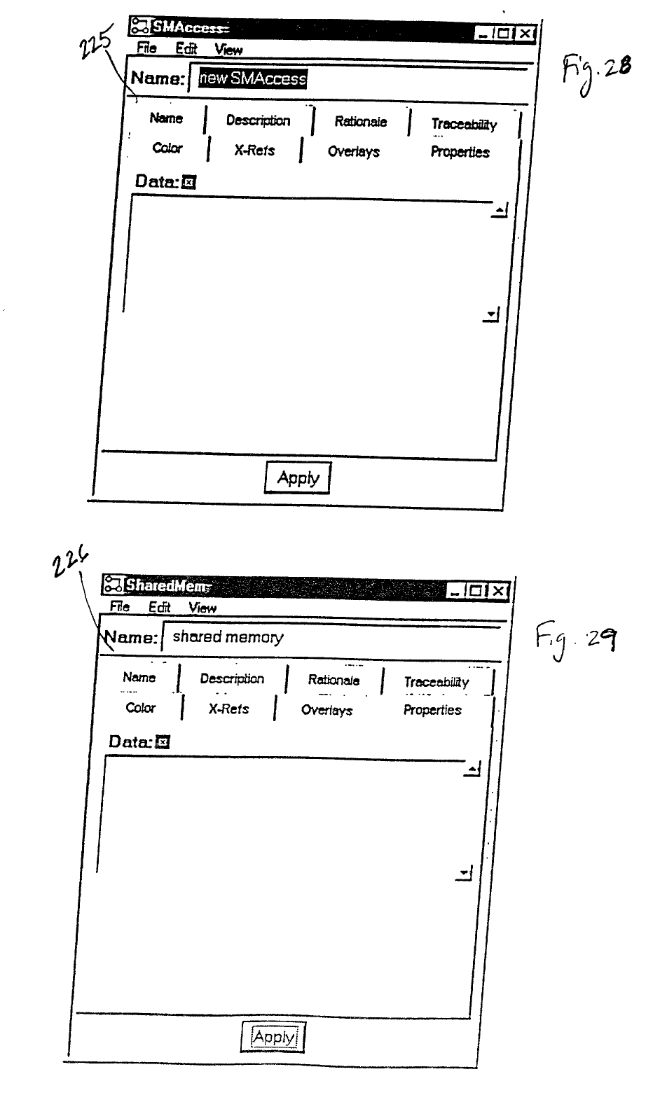

FIG. 20 shows parameter data input window 213, whereby a user may enter data through a computer workstation that further defines node 207 in FIG. 16. Although some of the parameters that may be defined (name, description, rationale, traceability, color of object, cross-references to other processes, and overlays) are the same for all nodes and arcs, parameter data input window 213 is associated with an aperiodic process, which will require different parameters to be associated through the parameter data input window than with the parameter data input windows of FIGS. 18 and 19. Parameter data input window 213 further allows a user to define process duration, command line arguments, process priority, process pathname, process deadline, processor number, and immediate processors, and associate them with the simulation process that the node represents.

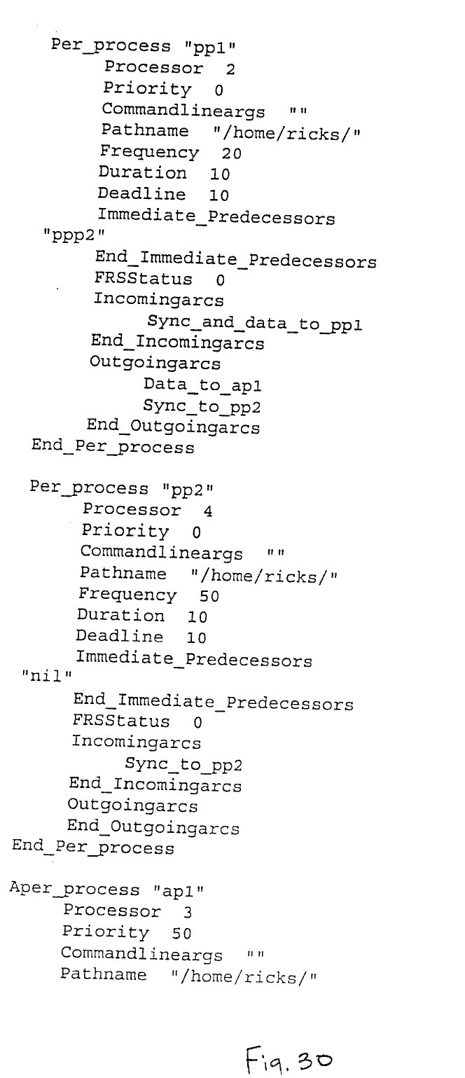

As mentioned, FIGS. 17 through 20 display parameter data input windows associated with the nodes visually described in FIG. 16. A user may also employ parameter data input windows to input parameter data associated with arcs as in FIG. 21. The only difference between associating parameter data with an arc and associating parameter data with a node lies in the definition of the properties associated with the arc or the node. Node properties will be related to process identity and function, while arc properties will relate to communication specifications. In FIG. 21, parameter data input window 214 allows the user to associate common quantities such as name and description with arc 209 in FIG. 16, and further allow for definition of communication frequency and release time details.

FIG. 22 shows graphical user interface 200, through which is viewed the specification details of arc 206 in FIG. 16. Arc 217 represents the communication between nodes 215 and 216, which represent the same periodic processes as nodes 204 and 205 in FIG. 16. The only difference between arc 217 in FIG. 22 and arc 206 in FIG. 16 is that arc 217 is more specific than arc 206 as to the type of communication being represented. The user workstation screen shown as FIG. 22 may be accessed by selecting container arc 206 in FIG. 16. The relationship shown in FIG. 22 is more implementation-specific than the relationship shown in FIG. 16, giving the user another level of abstraction to aid in comprehending and manipulating the representation of the simulation architecture.

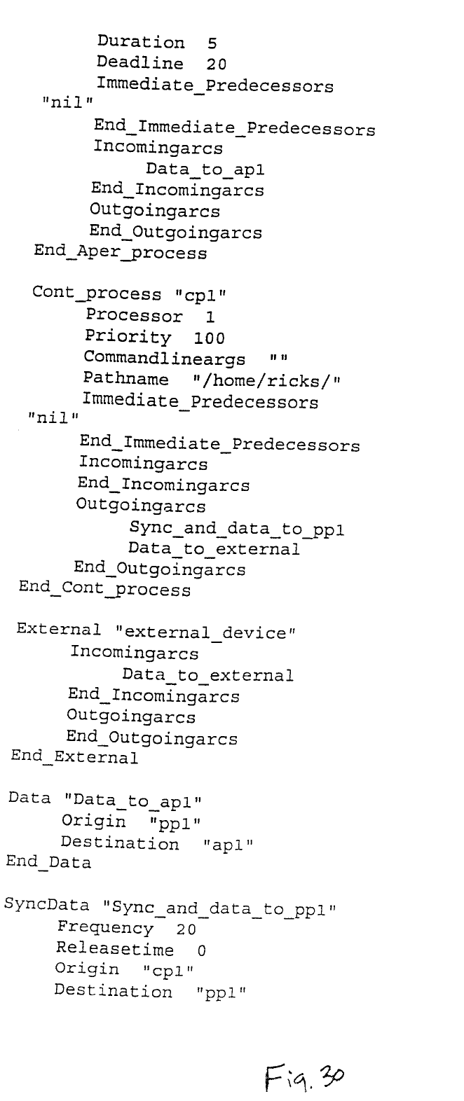

By using graphical user interface 200 in FIG. 22, the user may view the parameter data specific to arc 217, as is shown in parameter data input window 218 in FIG. 23. Parameter data input window 218 shows general properties such as name and description, and such communication-specific properties as communication frequency and communication release time.

FIG. 24 shows graphical user interface 200, through which is viewed a communication relationship between nodes 202 and 204. While nodes 202 and 204 are performing the same functions in FIGS. 16 and 24, arc 230 in FIG. 24 is a more implementation-specific representation than arc 209 in FIG. 16. In FIG. 24, arc 230 represents a message queue data relationship between node 202 and node 204.

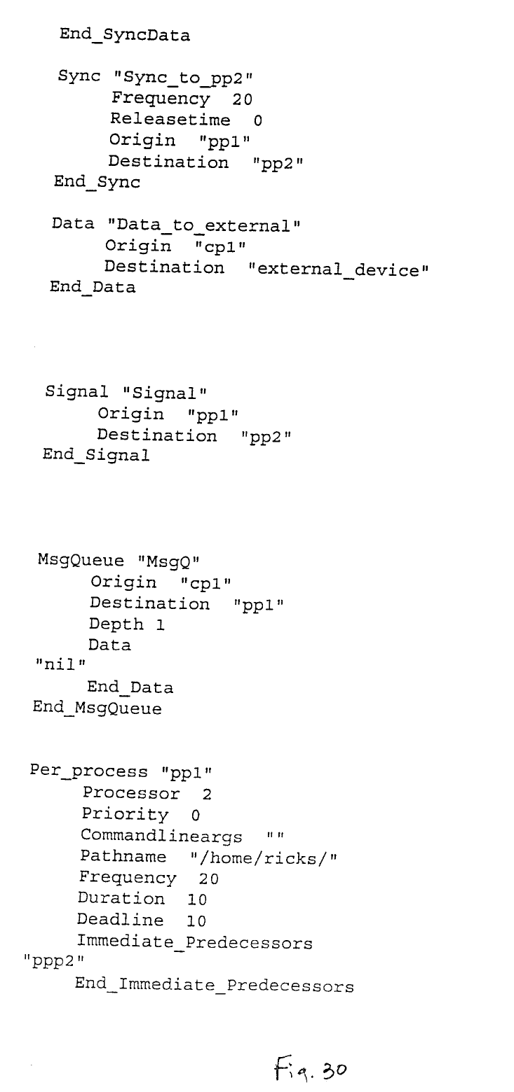

Just as the representation in FIG. 24 allows the user to view a more specific level of relationship between processes than FIG. 16, FIG. 25 allows an even more specific representation of a relationship, in that the properties of arc 230 may be accessed through parameter data input window 219. In addition to the properties generally associated with and definable to simulation node and arcs, parameter data input window 219 shows that the user may define the depth of the message queue and the data in the message queue, providing a highly-implementation specific level of information. At the same time, parameter data input window 219 only provides data to the user upon request, ensuring that the user will be able to control the level of specificity at which the simulation architecture is shown.

Referring to FIG. 26, parameter data input window 220 shows the implementation-level details of an arc. Parameter data input window 220 is not associated with any higher-level description in the drawings, but is illustrated for the purpose of showing another type of communication description. Data that may be defined relating to a new socket as in parameter data input window 220 may relate to general communication properties, as well as to specific properties such as data and communication port numbers.

Referring to FIG. 27, graphical user interface 200 is used to display the graphical contents of arc 208 in FIG. 16 (referred to as arc 221 in FIG. 27). Arc 221 is further defined as follows. Node 204 conveys data to node 207 through shared memory region 222 (shown as a rectangle representing a shared memory area in the simulation architecture). The data relationship between node 204 and shared memory area 222 is represented by arc 223. Shared memory region 222 is related to node 207 by a data relationship, graphically represented by arc 224, such that data is passed from node 204 through shared memory area 222 and to node 207 without alteration.

Referring to FIG. 28, parameter data input window 225 is associated with and further defines either arc 223 or arc 224 of FIG. 27 (since the parameters of both arcs are the same). In addition to standard arc parameters, a user may also view the content of the data being transferred in arc 223 or arc 224 through parameter data input window 225.

Referring to FIG. 29, parameter data input window 226 enables a user to access the implementation details of shared memory node 222 in FIG. 27. The user may view and change the specific data content of shared memory node 222, as well as the process name, description, and other node defining information.

Generation of Output Files and Simulation Code

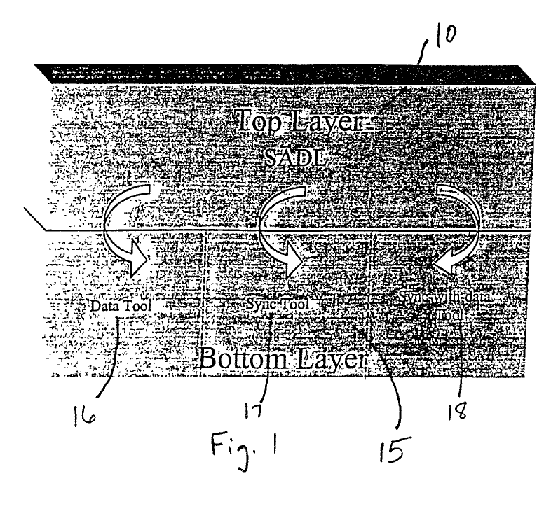

The system 10 of the invention can be used with other simulation tools. Referring to FIG. 1, the system 10 is shown as the top layer in a two-layer design tool diagram. Bottom layer 15 is a trifurcated layer that includes three groups of implementation-specific tools: data tools 16, sync tools 17, and sync-with-data tools 18. These tools reference a simulation architecture description from system 10 and specify how the simulation defined by a SADL description is actually implemented on a host computer. More specifically, the tools of bottom layer 15 include the three ways a communication can occur within the elements of a simulation that is being graphically represented by a simulation description: data communications, synchronization communications, and sync-with-data communications.

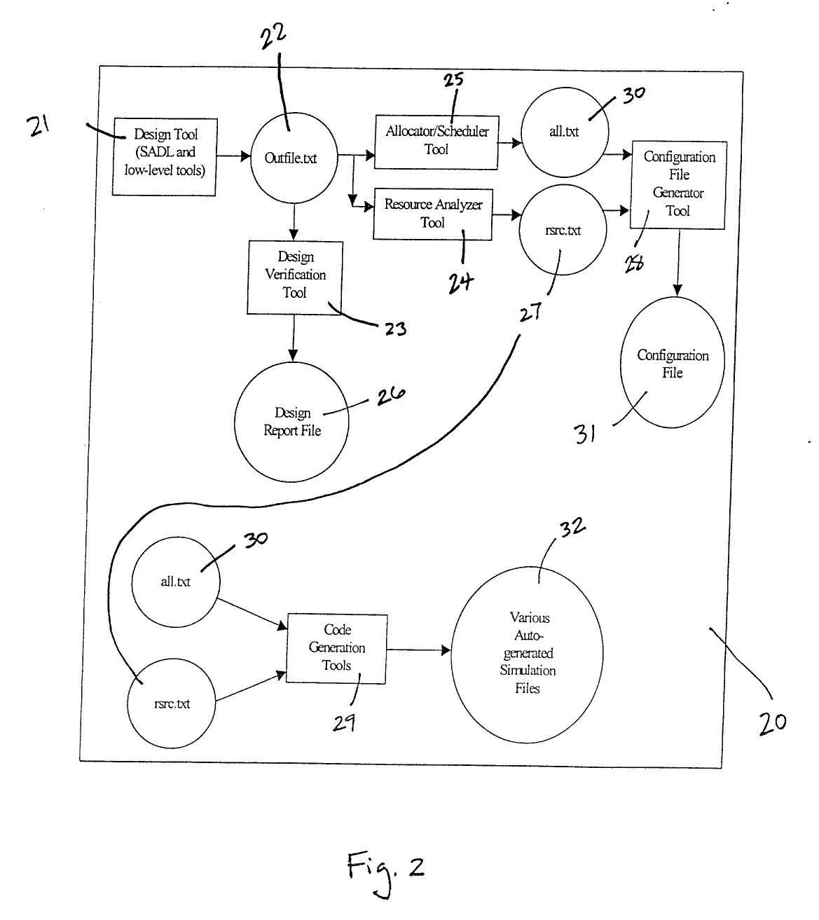

The simulation description and the lower-level tools that use the description as shown and described herein relating to FIG. 1 are primarily used for documentation and design purposes Furthermore, the description and lower-level tools work together to provide output that is used by so-called “downstream tools” for simulation analysis, evaluation, and code generation. Hence, FIG. 2 shows how the output of FIG. 1 is used to give further utility to the invention.

FIG. 2 is a flow diagram showing some of the uses of the output from system 10. Boxes in data flow diagram 20 represent tools, while circles represent outputs produced by a tool, and the data flow is indicated by directed lines. In FIG. 2, FIG. 1 is alternatively named “Design Tool” and reproduced in black-box form as block 21. The design tool of block 21 is the area where a user arranges simulation representations to visually describe the architecture of the simulation. The output of block 21 is output file 22, which is a text file description of the simulation architecture defined by the user in block 21.

Many downstream tools may use output file 22 for simulation design analysis, evaluation, and code generation. Several examples of such downstream tools are shown in FIG. 2. In a preferred embodiment, output file 22 is an ASCII text file. ASCII text files are easily recognized and accessed by most downstream tools that would use such output with respect to the present invention. Regardless of preferred format, though, output file 22 will describe the simulation architecture in a form readable by downstream tools.

Initially in FIG. 2, design verification tool 23, resource analyzer tool 24, and allocator/scheduler tool 25 receive output file 22 as input. Design verification tool 23 analyzes output file 22 and produces design report file 26, which may be used to analyze simulation architecture design. Resource analyzer tool 24 uses output file 22 to produce resource text file 27. Resource text file 27 may in turn be input to configuration file generator tool 28 or code generation tool 29 for the purpose of file or code generation, respectively. Similarly, allocation text file 30 acts as output from allocator/scheduler tool 25 and acts as input for either configuration file generator tool 28 or code generation tools 29 for file generation or code generation, respectively.

The architectural description created by the system is further available for use by a second level of downstream tools, two of which are shown in FIG. 2. Configuration file generator tool 28 produces a configuration file 31 as output, while code generation tools 29 provide an output of various auto-generated simulation files 32. FIG. 2 thus demonstrates scenarios in which a graphical description created by the system may be the basis for testing and analyzing the architecture of a simulation.

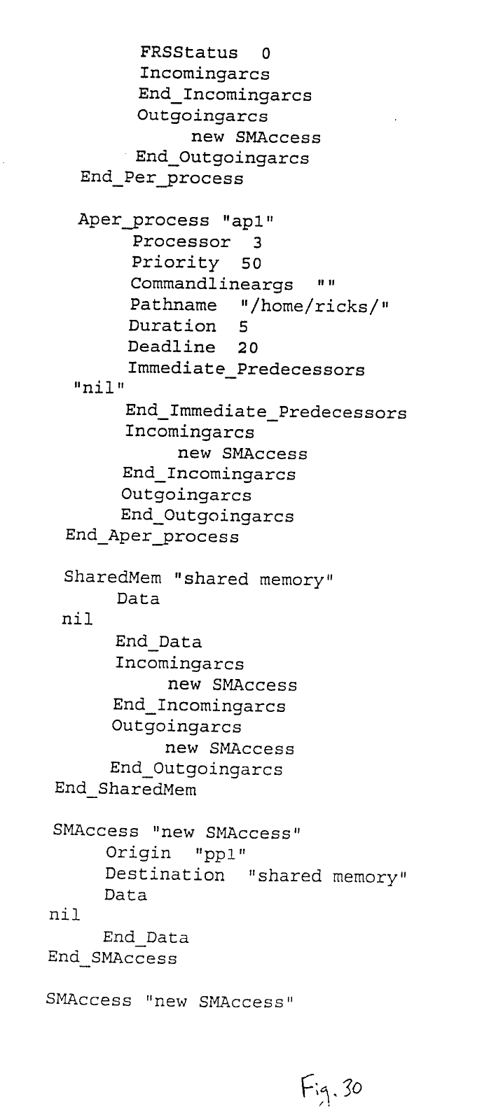

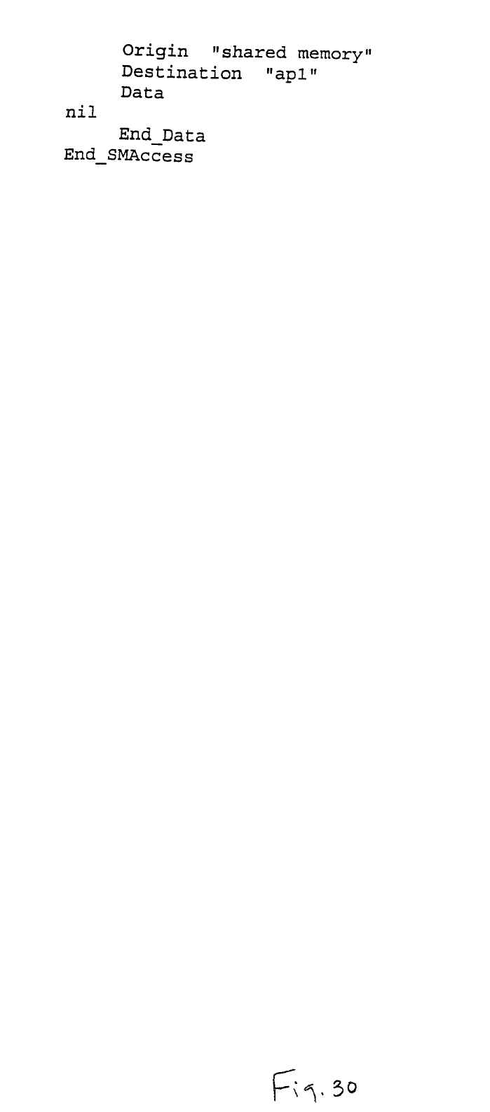

FIG. 30 is a computer printout of an output text file that is a representation of the simulation architecture graphically represented in FIG. 16. FIG. 30 is a text file generated by the output file module 275 (FIG. 31) that downstream tools may use to test and analyze the feasibility and quality of the simulation architecture.

Thus it is seen that the system and method of the present invention readily achieve the ends and advantages mentioned, as well as those inherent therein. While certain preferred embodiments have been illustrated and described for purposes of the present disclosure, numerous changes in parts and steps may be made by those skilled in the art, which changes are encompassed within the scope and spirit of the appended claims.

Thus, although there have been described particular embodiments of the present invention of a new and useful System and Method for Creating Architectural Descriptions of Real-Time Simulations, it is not intended that such references be construed as limitations upon the scope of this invention except as set forth in the following claims.

What is claimed is:

1. A system for enabling a user to create on a computer workstation a visually displayed architectural description of a computer simulation of a real system comprising:
a. a standardized set of graphical node elements representing each of a plurality of pre-defined real system components, the real system components including processes and real system hardware associated with the real system;
b. a standardized set of graphical arc elements representing each of a plurality of pre-defined timing, control, and data relationships that can be associated with the pre-defined real system components;
c. each of the graphical node elements and arc elements displayed at a graphical user interface on the workstation and selectable by the user whereby the user can position selected node elements in a user-defined arrangement and connect two or more of the selected node elements with one or more selected arc elements to create on the workstation the architectural description of the simulation of the real system;
d. a parameter data input window associated with at least some of the selected node and arc elements, the parameter data input window allowing the user to associate parameter data with the selected node and arc elements; and
e. simulation architecture data files describing:
the selected node and arc elements,
the user defined arrangement of the node and arc elements, and
the parameter data input by the user.

2. The system of claim 1 wherein the real system components represented by the standardized set of node elements include external hardware devices, periodic processes, aperiodic processes, and continuous processes.

3. The system of claim 2 wherein the standardized set of node elements further includes at least one simulation container representing in a single graphical node element a plurality of the real system components.

4. The system of claim 3 wherein the standardized set of node elements further includes a boundary node.

5. The system of claim 1 wherein the pre-defined timing, control, and data relationships represented by the standardized set of graphical arc elements include data transfer between processes, synchronization between processes, and synchronization with data transfer between processes.

6. The system of claim 5 wherein the standardized set of graphical arc elements further includes a communications container representing in a single graphical arc element a plurality of the timing, control, and data relationships.

7. The system of claim 5 wherein the synchronization relationship represented by one of the arc elements defines a synchronization mechanism between a first node element representing a source process and a second node element representing a destination process, and the parameter data that can be linked to the arc elements representing a synchronization mechanism includes a sync release time relative to an execution time of the source process and a sync frequency.

8. The system of claim 7 wherein the source and destination processes connected by an arc element representing a synchronization mechanism can each be periodic, aperiodic, or continuous.

9. The system of claim 8 wherein the synchronization mechanisms associated with an arc element selected by the user are tested for selection of an illegal synchronization relationship between node elements selected by the user.

10. The system of claim 9 wherein the illegal synchronization relationships tested by the system include:
a. connecting a periodic source process to a periodic destination process with an arc element representing an aperiodic synchronization mechanism;
b. connecting an aperiodic source process to a periodic destination process with an arc element representing a synchronization mechanism; and
c. connecting to a single process with multiple arc elements defining different synchronization mechanisms.

11. The system of claim 1 further comprising an output file generator operable to select and organize pre-defined portions of the simulation architecture data files into an electronic output file that can be used for generating computer code defining a computer simulation corresponding to the architectural description created by the user on the workstation.

12. A method of creating on a computer workstation a graphical description of the architecture of a simulation of a real world system comprising the steps of:
a. selecting at a graphical user interface one or more graphical node elements from a standardized set of graphical node elements displayed on the workstation, the selected node elements representing pre-defined real system components, including processes and real system hardware, associated with the real system;
b. selecting at the graphical user interface one or more graphical arc elements from a standardized set of graphical arc elements displayed on the workstation, the selected arc elements representing pre-defined timing, control, and data relationships between the selected node elements;
c. arranging on the graphical user interface the selected node elements and connecting the selected node elements with the selected arc elements to create and display on the workstation the architectural description of the simulation of the real system;
d. entering at one or more parameter data input windows associated with at least some of the selected node and arc elements parameter data that further defines properties of the selected node and arc elements found in the real world system; and
e. saving, in one or more simulation architecture data files, data about the selected node and arc elements, data about the user defined arrangement of the node and arc elements, and the parameter data input by the user.

13. The method of claim 12 further comprising the step of generating an output file containing selected portions of the simulation architecture data files.

14. The method of claim 12 wherein the real system components represented by the standardized set of node elements include external hardware devices, periodic processes, aperiodic processes, and continuous processes.

15. The method of claim 14 wherein the standardized set of node elements further includes at least one simulation container representing in a single node element a plurality of the real system components.

16. The method of claim 15 wherein the standardized set of node elements further includes a boundary node.

17. The method of claim 12 wherein the pre-defined timing, control, and data relationships represented by the standardized set of arc elements include data transfer between processes, synchronization between processes, and synchronization with data transfer between processes.

18. The method of claim 17 wherein the standardized set of arc elements further includes a communications container representing in a single arc element a plurality of the timing, control, and data relationships.

19. The method of claim 17 wherein the synchronization relationship represented by one of the arc elements defines a synchronization mechanism between a first node element representing a source process and a second node element representing a destination process, and the parameter data that can be associated with the arc elements representing a synchronization mechanism includes a sync release time relative to an execution time of the source process and a sync frequency.

20. The method of claim 19 wherein the source and destination processes connected by an arc element representing a synchronization mechanism can each be periodic, aperiodic, or continuous.

21. The method of claim 20 further comprising automatically testing the synchronization mechanisms associated with selected arc elements for use of an illegal synchronization relationship between selected node elements.

22. The method of claim 21 wherein the illegal synchronization relationships tested include:
a. connecting a periodic source process to a periodic destination process with an arc element representing an aperiodic synchronization mechanism;
b. connecting an aperiodic source process to a periodic destination process with an arc element representing a synchronization mechanism; and
c. connecting to a single process with multiple arc elements defining different synchronization mechanisms.

23. The method of claim 13 further comprising organizing data in the output file for use in generating computer code defining a computer simulation corresponding to the architectural description created by the user on the workstation.

24. A system for creating a graphical representation of the architecture of a computer simulation of a real world system comprising:
a. a computer workstation having a processor, display, keyboard, an operating system causing the processor to generate a cursor on the display, a pointing device for manipulating the cursor on the display, and a data storage device;
b. a first software module operable to generate a graphical user interface on the display;
c. a second software module operable to display on the graphical user interface a pre-defined set of graphical node elements, the node elements representing pre-defined real system components, the real system components including processes and real system hardware associated with the real system;
d. a third software module operable to display on the graphical user interface a pre-defined set of graphical arc elements, the arc elements representing pre-defined timing, control, and data relationships that can be associated with the real system components;
e. the second software module further operable to allow the user, using the pointing device, to select one or more of the node elements and position the selected node elements in a user-defined arrangement on the display corresponding to the simulation architecture;
f. the third software module further operable to allow the user, using the pointing device, to select one or more of the arc elements and position the selected arc elements on the display to connect the selected and positioned node elements so as to associate one of the pre-defined timing, control, and data relationships with the node elements connected by the selected arc elements;
g. a fourth software module operable, in conjunction with the graphical user interface, to open parameter data input windows linked to one or more of the selected node and arc elements and receive from the user parameter data further defining properties of the linked node and arc elements; and
h. the operating system further operable to store on the data storage device simulation architecture data files containing data representing:
the selected node and arc elements,
the arrangement of the selected node elements,
the connection of the selected node elements by the selected arc elements, and
the parameter data input by the user.

25. The system of claim 24 further comprising an output file generator module operable to select and organize pre-defined portions of the simulation architecture data files into an electronic output file that can be used for generating computer code that defines a computer simulation corresponding to the architectural description created by the user on the workstation.
